(19) United States
(12) Patent Application Publication
(10) Pub. No.: US 2026/0120315 A1
(43) Pub. Date: Apr. 30, 2026

(54) APPROACHES TO GENERATING SEMI-SYNTHETIC TRAINING DATA FOR REAL-TIME ESTIMATION OF POSE AND SYSTEMS FOR IMPLEMENTING THE SAME

(71) Applicant: Hinge Health, Inc., San Francisco, CA (US)

(72) Inventors: Sohail Zangenehpour, Beaconsfield (CA); Paul Anthony Kruszewski, Westmount (CA); Robert Lacroix, Saint-Lambert (CA); Colin Joseph Brown, Saskatoon (CA); Thomas Jan Mahamad, Montreal (CA)

(21) Appl. No.: 19/432,467

(22) Filed: Dec. 24, 2025

Related U.S. Application Data
(63) Continuation of application No. PCT/US24/41789, filed on Aug. 9, 2024.
(60) Provisional application No. 63/518,780, filed on Aug. 10, 2023.

(51) Int. Cl. G06T 7/73; G06T 15/08; G06T 15/20

(52) U.S. Cl. CPC G06T 7/73; G06T 15/08; G06T 15/205; G06T 2207/10016; G06T 2207/20081; G06T 2207/30196

(57) ABSTRACT

Systems and methods for generating synthetic training data for pose estimators based on volumetric video data are described herein. For example, the system may obtain volumetric videos of individuals. The system may generate multiple sets of view parameters. The system may generate 2D renderings of the volumetric videos in multiple volumetric scenes. The system may generate transformed 2D representations from renderings of the volumetric videos in a virtual studio. The system may provide a training dataset to a machine learning algorithm to produce a machine learning model.

### CROSS-REFERENCE TO RELATED APPLICATIONS

This application is a continuation of International Patent Application No. PCT/US2024/041789, titled “Approaches to Generating Semi-Synthetic Training Data for Real-Time Estimation of Pose and Systems for Implementing the Same” and filed Aug. 9, 2024, which claims priority to U.S. Provisional Application No. 63/518,780, titled “Approaches to Generating Semi-Synthetic Training Data for Real-Time Estimation of Pose and Systems for Implementing the Same” and filed on Aug. 10, 2023, each of which is incorporated by reference herein in its entirety.

### TECHNICAL FIELD

Various embodiments concern computer programs designed to improve performance of estimating poses in various environments and associated systems and methods.

### BACKGROUND

Pose estimation (also called “pose detection”) is an active area of study in the field of computer vision. Over the last several years, tens—if not hundreds—of different approaches have been proposed in an effort to solve the problem of pose detection. Many of these approaches rely on machine learning due to its programmatic approach to learning what constitutes a pose.

As a field of artificial intelligence, computer vision enables machines to perform image processing tasks with the aim of imitating human vision. Pose estimation is an example of a computer vision task that generally includes detecting, associating, and tracking the movements of a person. This is commonly done by identifying “key points” that are semantically important to understanding pose. Examples of key points include “head,” “left shoulder,” “right shoulder,” “left knee,” and “right knee. ” Insights into posture and movement can be drawn from analysis of these key points.

### BRIEF DESCRIPTION OF THE DRAWINGS

FIG. 1 illustrates a network environment that includes a motion monitoring platform that is executed by a computing device.

FIG. 2A illustrates an example of a computing device able to implement a program in which a user is requested to perform physical activities, such as exercises, during sessions by a motion monitoring platform.

FIG. 2B illustrates an example of a training module for generating training data to improve motion monitoring.

FIG. 3A depicts an example of a communication environment that includes a motion monitoring platform configured to receive several types of data.

FIG. 3B depicts another example of a communication environment that includes a motion monitoring platform configured to obtain data from one or more sources.

FIG. 4A depicts a flow diagram of a process for generating labelled skeletal representations for training a machine learning model to estimate pose.

FIG. 4B depicts a flow diagram of a process for generating two-dimensional (2D) renderings of volumetric videos for generation of training data for the machine learning model.

FIG. 4C depicts a flow diagram of a process for training a machine learning model to monitor motion based on generating training data and corresponding skeletal representations.

FIG. 5 depicts an example of a virtual studio, in accordance with one or more embodiments.

FIG. 6 depicts a flowchart for estimating a ground truth skeleton and realistic images and videos.

FIG. 7 depicts a flowchart for generating skeletal representations and ground truth scenes based on volumetric video data.

FIG. 8 depicts generated training data for training a machine learning model for the motion monitoring platform.

FIG. 9 is a block diagram illustrating an example of a processing system in which at least some operations described herein can be implemented.

Various features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the technology. Accordingly, although specific embodiments are shown in the drawings, the technology is amenable to various modifications.

### DETAILED DESCRIPTION

Over the last several years, significant advances have been made in the field of computer vision. This has resulted in the development of sophisticated pose estimation programs (also called “pose estimators” or “pose predictors”) that are designed to perform pose estimation in either two dimensions or three dimensions. Two-dimensional (“2D”) pose estimators predict the 2D spatial locations of key points, generally through the analysis of the pixels of a single digital image. Three-dimensional (“3D”) pose estimators predict the 3D spatial arrangement of key points, generally through the analysis of the pixels of multiple digital images, for example, consecutive frames in a video, or a single digital image in combination with another type of data generated by, for example, an inertial measurement unit (“IMU”) or Light Detection and Ranging (“LiDAR”) unit.

Pose estimators—both 2D and 3D—continue to be applied to different contexts, and as such, continue to be used to help solve different problems. One problem for which pose estimators have proven to be particularly useful is monitoring the performance of physical activities. Consider, for example, a scenario where an individual is instructed or prompted to perform a physical activity by a computer program. By applying a pose estimator to digital images of the individual, the computer program can glean insight into performance of the physical activity. Historically, the individual may have instead been asked to summarize her performance of the physical activity (e.g., in terms of difficulty); however, this type of manual feedback tends to be inaccurate and inconsistent. Due to their consistent, programmatic nature, pose estimators allow for more accurate monitoring of performances of physical activities.

This is especially important if the pose estimator is responsible for monitoring physical activities that have meaningful real-world impact, such as on the health and wellness of the individual responsible for performing the physical activities. Exercise therapy is an intervention technique that utilizes physical activities as the principal treatment for addressing the symptoms of musculoskeletal (“MSK”) conditions, such as acute physical ailments and chronic physical ailments. Exercise therapy programs (or simply “programs”) generally involve a plan for performing physical activities during exercise therapy sessions (or simply “sessions”) that occur on a periodic basis. Normally, the purpose of a program is to either restore normal MSK functionality or reduce the pain caused by a physical ailment, which may have been caused by injury or disease.

In conventional systems, a pose estimation system may receive, as input, videos or images corresponding to multiple users carrying out different poses over time. In addition, conventional systems may manually generate ground truth poses corresponding to each image or frame. Based on both these images and the corresponding ground truth poses, conventional systems may train a pose estimator to monitor poses carried out by users. However, such pose estimators require sufficient training data for accurate pose monitoring. Pose estimators may require video- or image-based data corresponding to humans carrying out poses. For example, large amounts of high-quality images associated with multiple users may be necessary for pose estimators to generate accurate predictions of a human's pose (e.g., in 2D or 3D). Furthermore, because images or video recordings of humans may include extraneous objects (e.g., furniture or disparate backgrounds), aberrations (e.g., due to faults in user cameras), or other imperfections or variations, sufficient training data must be acquired to sample these variations for the pose estimator to generate accurate pose predictions in a wide variety of circumstances.

Furthermore, conventionally generated training data may be limited to environments, poses, or camera angles that are physically recorded or captured. For example, conventional systems may be limited by pre-existing or previously available recordings of human poses in pre-existing environments. As such, conventional systems are limited in their ability to improve pose monitoring in situations in which the pose estimator is known to exhibit low accuracy. As an illustrative example, a conventional system may be known to generate errors in pose estimation in situations with wallpaper backgrounds of certain colors or patterns. However, as training data may be limited to existing videos, it may be difficult, if not impossible, for the conventional system to correct such errors in the absence of training data that includes the same types of wallpaper backgrounds. Simply put, conventional systems may not have access to targeted training data for improving pose estimation in specific circumstances that are known to generate errors.

Moreover, conventional systems may not utilize training data that captures a wide variety of perspectives associated with 2D images of humans performing poses. For example, even if a particular pose is included within training data for a conventional 2D pose monitoring model, the model may fail in situations where the same pose is performed at a different angle to the camera. As such, model accuracy tends to highly correlate to the particular 2D projection of a given 3D environment included in the training data, such that other 2D projections of the same environment may cause accuracy issues.

Introduced here is an approach to generate training data for motion monitoring artificially based on volumetric videos of humans carrying out poses. By generating training data semi-synthetically, the motion monitoring platform disclosed herein enables accurate and targeted generation of training data for improvements to pose estimation accuracy. For example, the motion monitoring platform provides the benefit of generating training data based on factors determined to reduce pose estimation accuracy, such as light levels, camera angle, background color, clothing color, camera field of view or extraneous background objects. The motion monitoring platform may generate training data that includes approximations of such factors within artificially generated videos or images, thereby improving the quality poses estimated by the motion monitoring platform.

In order to improve the performance of pose estimation, the motion monitoring platform disclosed herein leverages volumetric videos of humans to generate 3D renderings of the humans in a variety of scenes, with a variety of backgrounds, objects, lighting conditions, or image quality. In some implementations, the system can generate 2D renderings of volumetric videos within a customizable environment in a virtual scene. The motion monitoring platform can also generate a ground-truth skeletal representation based on placing the volumetric video in a virtual studio in order to represent the human's pose. The motion monitoring platform can transform and project this 3D skeletal representation in 2D according to the perspective of the virtual scene in order to generate a 2D ground-truth pose associated with the volumetric video. As such, the motion monitoring platform enables generation of training data based on the 2D renderings and the ground-truth skeletal structure.

For example, a training module associated with the motion monitoring platform can generate the ground-truth skeleton by placing the volumetric video of a human in a virtual scene (e.g., with a background of a color or texture that is not within the volumetric video). The training module can capture a variety of views of the volumetric video and determine 2D keypoints indicating anatomical landmarks for the human for each view. Based on these 2D keypoints, the training module can estimate corresponding 3D keypoints for each anatomical landmark to generate a 3D skeletal representation of the human. The 3D skeletal representation can form the basis of a ground-truth indication of the human's pose for a chosen 2D projection of the video.

To illustrate, the training module for the motion monitoring platform can place the same volumetric video in a virtual scene with other objects, backgrounds, or characteristics to be represented within training data for the motion monitoring platform. For example, the training module can place the volumetric video in a random location within a virtually generated scene that includes furniture, walls, or other objects or elements. The training module can capture the volumetric video within the scene from various perspectives to generate corresponding training images for the motion monitoring platform. Each of these perspectives can be associated with a transformation (e.g., a rotation and/or translation) from a reference perspective. The training module can correlate these perspectives and transformations with corresponding projections of the 3D skeletal representation generated previously. As such, the training module can generate a pair of synthetically generated training data, thereby enabling custom, targeted training of the motion monitoring platform (and more specifically, of its pose estimator).

As such, the training module provides the benefit of enabling selective generation of training data to target circumstances that cause accuracy issues for the model monitoring platform. For example, in some implementations, the model monitoring platform determines lighting conditions, backgrounds, clothing, or objects that are correlated with low pose estimation or motion monitoring accuracy. Based on this determination, the system can generate training data based on rendering a volumetric video of a human within a scene that represents the lighting conditions, backgrounds, or objects associated with the accuracy issues. As such, the training module enables targeted generation of training data without relying on newly captured training data that has the same characteristics as the problematic model inputs. Thus, the motion monitoring platform can improve the speed and cost of improving the accuracy of the motion monitoring model by requiring fewer images or videos of humans performing poses.

Furthermore, the training module provides the benefit of generating both 3D and 2D training data. For example, the motion monitoring platform can generate 2D and 3D representations of humans in a variety of positions, orientations, and angles within a virtual scene. As such, the system enables generation of 3D data, as well as 2D data (e.g., through projections of 3D data) for further training the motion monitoring model. Thus, the training methods disclosed herein can aid in training of both 2D and 3D pose monitoring models, thereby improving its robustness and flexibility.

For the purpose of illustration, embodiments may be described with reference to exercises that are performed during sessions as part of a program. However, the motion monitoring platform could be designed to monitor performance of other physical activities, such as sporting activities, cooking activities, art activities, and the like. Accordingly, the approach described herein could be used to provide personalized feedback regarding performance of nearly any physical activity.

For the purpose of illustration, embodiments may be described with reference to digital images—either single digital images or series of digital images, for example, in the form of a video—that include one or more humans. However, the motion monitoring platform could be designed to monitor movement of any living body. As an example, the motion monitoring platform may be designed—and its pose estimator trained—to monitor movement of cats, dogs, or horses for the purpose of detecting injury. Accordingly, the approach described herein could be used to generate semi-synthetic training data that includes different types of living bodies.

Moreover, embodiments may be described in the context of computer-executable instructions for the purpose of illustration. However, aspects of the approach could be implemented via hardware or firmware instead of, or in addition to, software. As an example, the motion monitoring platform may be embodied as a computer program that offers support for completing exercises during sessions as part of a program, determines which physical activities are appropriate for a user given performance during past sessions, and enables communication between the user and one or more coaches. The term “coach” may be used to generally refer to individuals who prompt, encourage, or otherwise facilitate engagement by users with the motion monitoring platform. Coaches are generally not healthcare professionals but could be in some embodiments.

### Terminology

References in the present disclosure to “an embodiment” or “some embodiments” mean that the feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the terms “comprise,” “comprising,” and “comprised of” are to be construed in an inclusive sense rather than an exclusive or exhaustive sense. That is, in the sense of “including but not limited to.” The term “based on” is also to be construed in an inclusive sense. Thus, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively coupled to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing all tasks.

When used in reference to a list of multiple items, the word “or” is intended to cover all of the following interpretations: any of the items in the list, all of the items in the list, and any combination of items in the list.

### Overview of Motion Monitoring Platform

A motion monitoring platform may be responsible for monitoring the motion of an individual (also called a “user,” “patient,” or “participant”) through analysis of digital images that contain her and are captured as she completes a physical activity. As an example, the motion monitoring platform may guide the user through exercise therapy sessions (or simply “sessions”) that are performed as part of an exercise therapy program (or simply “program”). As part of the program, the user may be requested to engage with the motion monitoring platform on a periodic basis. The frequency with which the user is requested to engage with the motion monitoring platform may be based on factors such as the anatomical region for which therapy is needed, the MSK condition for which therapy is needed, the difficulty of the program, the age of the user, the amount of progress that has been achieved, and the like.

As the user performs exercises, she may be recorded by a camera of a computing device. Normally, the camera is part of the computing device on which the motion monitoring is executed or accessed. For example, in order to initiate a session, the user may initiate a mobile application that is stored on, and executable by, her mobile phone or tablet computer, and the mobile application may instruct the user to position her mobile phone or tablet computer in such a manner that one of its cameras can record her as exercises are performed. Note that, in some embodiments, the camera is part of another computing device. For example, the camera may be included in a peripheral computing device, such as a web camera (also called a “webcam”), that is connected to the computing device. By examining the digital images that are output by the camera, the motion monitoring platform can monitor performance the exercises by estimating the pose of the user over time.

As mentioned above, the motion monitoring platform could alternatively estimate pose in contexts that are unrelated to healthcare, for example, to improve technique. As an example, the motion monitoring platform may estimate pose of an individual while she completes a sporting activity (e.g., performs a dance move, performs a yoga move, shoots a basketball, throws a baseball, swings a golf club), a cooking activity, an art activity, etc. Accordingly, while embodiments may be described in the context of a user who completes an exercise during a session as part of a program, the features of those embodiments may be similarly applicable to individuals performing other types of physical activities. Individuals whose performances of physical activities are analyzed may be referred to as “users” of the motion monitoring platform, even if these individuals have little to no opportunity to interact with the motion monitoring platform.

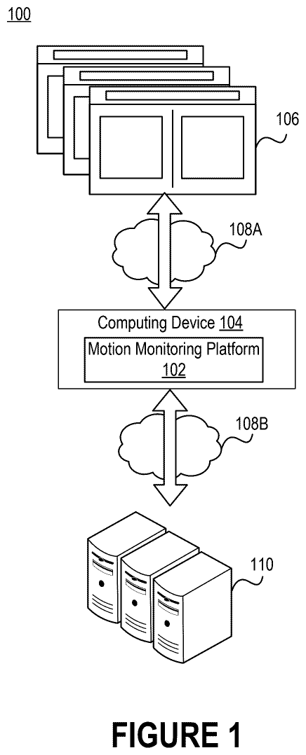

FIG. 1 illustrates a network environment 100 that includes a motion monitoring platform 102 that is executed by a computing device 104. Users can interact with the motion monitoring platform 102 via interfaces 106. For example, users may be able to access interfaces that are designed to guide them through physical activities, indicate progress, present feedback, etc. As another example, users may be able to access interfaces through which information regarding completed physical activities can be reviewed, feedback can be provided, etc. Thus, interfaces 106 may serve as informative spaces, or the interfaces 106 may serve as collaborative spaces through which users and coaches can communicate with one another.

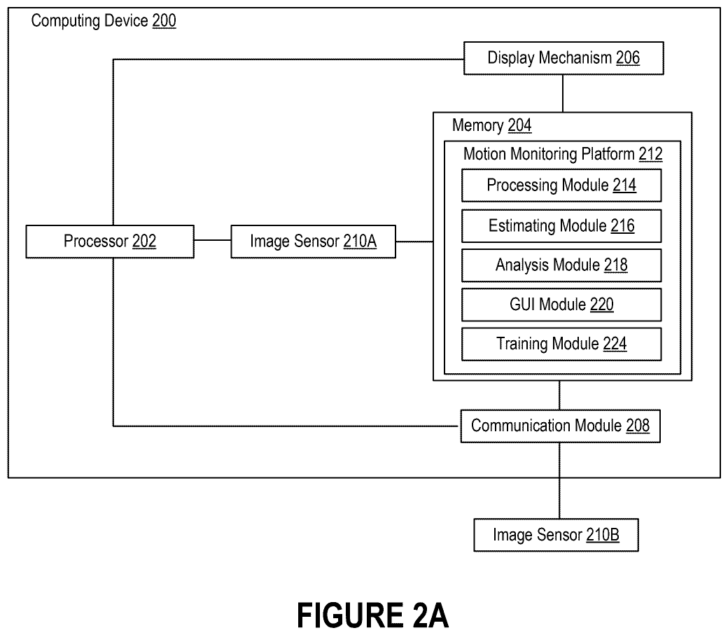

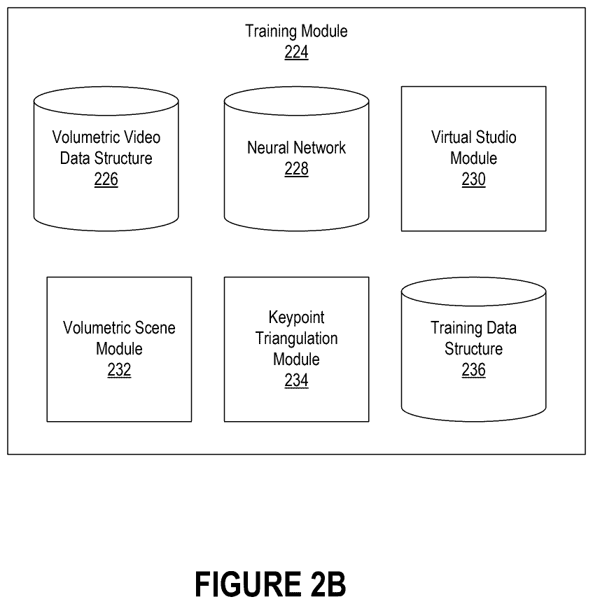

As shown in FIG. 2, the motion monitoring platform 102 may reside in a network environment 100. Thus, the computing device on which the motion monitoring platform 102 is executing may be connected to one or more networks 106A-B. Depending on its nature, the computing device 104 could be connected to a personal area network (“PAN”), local area network (“LAN”), wide area network (“WAN”), metropolitan area network (“MAN”), or cellular network. For example, if the computing device 104 is a mobile phone, then the computing device 104 may be connected to a computer server of a server system 110 via the Internet. As another example, if the computing device 104 is a computer server, then the computing device 104 may be accessible to users via respective computing devices that are connected to the Internet via LANs.

The interfaces 106 may be accessible via a web browser, desktop application, mobile application, or another form of computer program. For example, to interact with the motion monitoring platform 102, a user may initiate a web browser on the computing device 104 and then navigate to a web address associated with the motion monitoring platform 102. As another example, a user may access, via a desktop application or mobile application, interfaces that are generated by the motion monitoring platform 102 through which she can select physical activities to complete, review analyses of her performance of the physical activities, and the like. Accordingly, interfaces generated by the motion monitoring platform 102 may be accessible via various computing devices, including mobile phones, tablet computers, desktop computers, wearable electronic devices (e.g., watches or fitness accessories), virtual reality systems, augmented reality systems, and the like.

Generally, the motion monitoring platform 102 is hosted, at least partially, on the computing device 104 that is responsible for generating the digital images to be analyzed, as further discussed below. For example, the motion monitoring platform 102 may be embodied as a mobile application executing on a mobile phone or tablet computer. In such embodiments, the instructions that, when executed, implement the motion monitoring platform 102 may reside largely or entirely on the mobile phone or tablet computer. Note, however, that the mobile application may be able to access a server system 110 on which other aspects of the motion monitoring platform 102 are hosted.

In some embodiments, aspects of the motion monitoring platform 102 are executed by a cloud computing service operated by, for example, Amazon Web Services®, Google Cloud Platform™, or Microsoft Azure®. Accordingly, the computing device 104 may be representative of a computer server that is part of a server system 110. Often, the server system 110 is comprised of multiple computer servers. These computer servers can include information regarding different physical activities; computer-implemented models (or simply “models”) that indicate how anatomical regions should move when a given physical activity is performed; computer-implemented templates (or simply “templates”) that indicate how anatomical regions should be positioned when partially or fully engaged in a given physical activity; algorithms for processing image data from which spatial position of anatomical regions can be computed, inferred, or otherwise determined; user data such as name, age, weight, ailment, enrolled program, duration of enrollment, and number of physical activities completed; and other assets.

FIG. 2A illustrates an example of a computing device 200 that is able to execute a motion monitoring platform 212. As mentioned above, the motion monitoring platform 212 can facilitate the performance of physical activities by a user, for example, by providing instruction or encouragement. As shown in FIG. 2A, the computing device 200 can include a processor 202, memory 204, display mechanism 206, communication module 208, and image sensor 210A. In some implementations, the computing device can include audio output or audio input mechanisms. Each of these components is discussed in greater detail below.

Those skilled in the art will recognize that different combinations of these components may be present depending on the nature of the computing device 200. For example, if the computing device 200 is a computer server that is part of a server system (e.g., server system 110 of FIG. 1), then the computing device 200 may not include the display mechanism 206, image sensor 210A, an audio output mechanism, or an audio input mechanism, though the computing device 200 may be communicatively connectable to another computing device that does include a display mechanism, an image sensor, an audio output mechanism, or an audio input mechanism.

The processor 202 can have generic characteristics similar to general-purpose processors, or the processor 202 may be an application-specific integrated circuit (“ASIC”) that provides control functions to the computing device 200. As shown in FIG. 2, the processor 202 can be coupled to all components of the computing device 200, either directly or indirectly, for communication purposes.

The memory 204 may be comprised of any suitable type of storage medium, such as static random-access memory (“SRAM”), dynamic random-access memory (“DRAM”), electrically erasable programmable read-only memory (“EEPROM”), flash memory, or registers. In addition to storing instructions that can be executed by the processor 202, the memory 204 can also store data generated by the processor 202 (e.g., when executing the modules of the motion monitoring platform 212) and produced, retrieved, or obtained by the other components of the computing device 200. For example, data received by the communication module 208 from a source external to the computing device 200 (e.g., image sensor 210B) may be stored in the memory 204, or data produced by the Image sensor 210A may be stored in the memory 204. Note that the memory 204 is merely an abstract representation of a storage environment. The memory 204 could be comprised of actual integrated circuits (also referred to as “chips”).

The display mechanism 206 can be any mechanism that is operable to visually convey information to a user. For example, the display mechanism 206 may be a panel that includes light-emitting diodes (“LEDs”), organic LEDs, liquid crystal elements, or electrophoretic elements. In some embodiments, the display mechanism 206 is touch sensitive. Thus, a user may be able to provide input to the motion monitoring platform 212 by interacting with the display mechanism 206. Alternatively, the user may be able to provide input to the motion monitoring platform 212 through some other control mechanism.

The communication module 208 may be responsible for managing communications external to the computing device 200. For example, the communication module 208 may be responsible for managing communications with other computing devices (e.g., server system 110 of FIG. 1, or a camera peripheral such as video camera or webcam). The communication module 208 may be wireless communication circuitry that is designed to establish communication channels with other computing devices. Examples of wireless communication circuitry include 2.4 gigahertz (“GHz”) and 5 GHz chipsets compatible with Institute of Electrical and Electronics Engineers (“IEEE”) 802.11—also referred to as “Wi-Fi chipsets.” Alternatively, the communication module 208 may be representative of a chipset configured for Bluetooth®, Near Field Communication (“NFC”), and the like. Some computing devices—like mobile phones and tablet computers—are able to wirelessly communicate via separate channels. Accordingly, the communication module 208 may be one of multiple communication modules implemented in the computing device 200. As an example, the communication module 208 may initiate and then maintain one communication channel with a camera peripheral (e.g., via Bluetooth), and the communication module 208 may initiate and then maintain another communication channel with a server system (e.g., via the Internet).

The nature, number, and type of communication channels established by the computing device 200—and more specifically, the communication module 208—may depend on the sources from which data is received by the motion monitoring platform 212 and the destinations to which data is transmitted by the motion monitoring platform 212. Assume, for example, that the computing device 200 is representative of a mobile phone or tablet computer that is associated with (e.g., owned by) a user. In some embodiments the communication module 208 may only externally communicate with a computer server, while in other embodiments the communication module 208 may also externally communicate with a source from which to receive image data. The source could be another computing device (e.g., a mobile phone or camera peripheral that includes an image sensor 210B) to which the mobile device is communicatively connected. Image data could be received from the source even if the mobile phone generates its own image data. Thus, image data could be acquired from multiple sources, and these image data may correspond to different perspectives of the user performing a physical activity. Regardless of the number of sources, image data—or analyses of the image data—may be transmitted to the computer server for storage in a digital profile that is associated with the user. The same may be true if the motion monitoring platform 212 only acquires image data generated by the image sensor 210A. The image data may initially be analyzed by the motion monitoring platform 212, and then the image data—or analyses of the image data—may be transmitted to the computer server for storage in the digital profile.

The image sensor 210A may be any electronic sensor that is able to detect and convey information in order to generate images, generally in the form of image data (also called “pixel data”). Examples of image sensors include charge-coupled device (“CCD”) sensors and complementary metal-oxide semiconductor (“CMOS”) sensors. The image sensor 210A may be part of a camera module (or simply “camera”) that is implemented in the computing device 200. In some embodiments, the image sensor 210A is one of multiple image sensors implemented in the computing device 200. For example, the image sensor 210A could be included in a front- or rear-facing camera on a mobile phone. Alternatively, the image sensor 210A may be externally connected to the computing device 200 such that the image sensor 210A captures image data of an environment and sends the image data to the to the motion monitoring platform 212.

For convenience, the motion monitoring platform 212 may be referred to as a computer program that resides in the memory 204. However, the motion monitoring platform 212 could be comprised of hardware or firmware in addition to, or instead of, software. In accordance with embodiments described herein, the motion monitoring platform 212 may include a processing module 214, pose estimating module 216, analysis module 218, graphical user interface (“GUI”) module 220, and a training module 224. These modules can be an integral part of the motion monitoring platform 212. Alternatively, these modules can be logically separate from the motion monitoring platform 212 but operate “alongside” it. Together, these modules may enable the motion monitoring platform 212 to programmatically monitor motion of users during the performance of physical activities, such as exercises, through analysis of digital images generated by the image sensor 210.

The processing module 214 can process image data obtained from the image sensor 210A over the course of a session. The image data may be used to infer a spatial position or orientation of one or more anatomical regions as further discussed below. The image data may be representation of a series of digital images. These digital images may be discretely captured by the image sensor 210A over time, such that each digital image captured the user at different stages of performing a physical activity. In some embodiments, these digital images may be representative of frames of a video that is captured by the image sensor 210. In such embodiments, the image data could also be called “video data.”

The image data may be used to infer a spatial position of one or more anatomical regions as further discussed below. For example, the processing module 214 may perform operations (e.g., filtering noise, changing contrast, reducing size) to ensure that the data can be handled by the other modules of the motion monitoring platform 212. As another example, the processing module 214 may temporally align the data with data obtained from another source (e.g., another image sensor) if multiple data are to be used to establish the spatial position of the anatomical regions of interest.

Moreover, the processing module 214 may be responsible for processing information input by users through interfaces generated by the GUI module 220. For example, the GUI module 220 may be configured to generate a series of interfaces that are presented in succession to a user as she completes physical activities as part of a session. On some or all of these interfaces, the user may be prompted to provide input. For example, the user may be requested to indicate (e.g., via a verbal command or tactile command provided via, for example, the display mechanism 206) that she is ready to proceed with the next physical activity, that she completed the last physical activity, that she would like to temporarily pause the session, etc. These inputs can be examined by the processing module 214 before information indicative of these inputs is forwarded to another module.

The pose estimating module 216 (or simply “estimating module”) may be responsible for estimating the pose of the user through analysis of image data, in accordance with the approach further discussed below. Specifically, the estimating module 216 can create, based on a digital image (e.g., generated by the image sensor 210A or image sensor 210B), a skeletal frame that specifies a spatial position of each of multiple anatomical regions. For example, the estimating module 216 can apply a computer-implemented model (or simply “model”) referred to as a pose estimator to the digital image, so as to produce the skeletal frame. In some embodiments the pose estimator is designed and trained to identify a predetermined number of joints (e.g., left and right wrist, left and right elbow, left and right shoulder, left and right hip, left and right knee, left and right ankle, or any combination thereof), while in other embodiments the pose estimator is designed and trained to identify all joints that are visible in the digital image provided as input. The pose estimator could be a neural network that when applied to the digital image, analyzes the pixels to independently identify digital features that are representative of each anatomical region of interest.

The analysis module 218 may be responsible for establishing the locations of anatomical regions of interest based on the outputs produced by the estimating module 216. Referring again to the aforementioned examples, the analysis module 216 could establish the locations of joints based on an analysis of the skeletal frame. Moreover, the analysis module 218 may be responsible for determining appropriate feedback for the user based on the outputs produced by the estimating module 216, in accordance with the approach further discussed below. Specifically, the analysis module 218 may determine an appropriate personalized recommendation for the user based on her current position, and a determination as to how her current position compares to a template that is associated with the physical activity that she has been instructed to perform.

The training module 224 may be responsible for generating training data for the motion monitoring platform 212 and/or updating model parameters of the pose estimator. For example, the motion monitoring platform 212 may include the training module 224 that is responsible for training the pose estimator that is employed by the pose estimating module 216. The training module 224 may generate training data for training the pose estimator based on volumetric videos of humans performing poses. For example, the training module 224 may communicate with and/or obtain video data from the server 110 for generation of ground-truth skeletal representations of humans, as well as corresponding renderings of the volumetric video within a synthetically generated scene. Based on this data, the training module 224 can train the pose estimator to improve predictions of a user's pose in circumstances similar to the synthetically generated scene.

FIG. 2B illustrates an example of a training module for generating training data to improve motion monitoring. For example, the training module 224 may include various functions for generating training data for a pose estimator and/or applying this training data to the pose estimator to update the model to generate accurate predictions of human poses based on input images or videos. The training module 224 may include a volumetric video data structure 226, neural network 228, virtual studio module 230, volumetric scene module 232, keypoint triangulation module 234, and/or a training data structure 236. The training module 224 may include additional modules or functions related to training pose estimators or other models associated with the motion monitoring platform 212.

For example, as shown in FIG. 2B, the training model 224 may include a volumetric video data structure 226. The volumetric video data structure 226 may include data and information associated with volumetric videos, such as for the purpose of training the pose estimator. As an illustrative example, the volumetric video data structure may include a volumetric video, including frames associated with the volumetric video.

A volumetric video (e.g., a volumetric capture) may include a capture of a 3D space. For example, the motion monitoring platform 212 can access the server 110 to acquire images of humans performing poses, where such images indicate 3D surfaces or structures associated with a human's anatomical features. As an illustrative example, volumetric videos of humans may be captured through light detection and ranging (“LIDAR”), or through multiple cameras capturing various perspectives or angles of images associated with a given object, such as a human (e.g., through photogrammetry and subsequent triangulation).

A volumetric video data structure 226 may include image files associated with visible textures captured on an object, as well as corresponding definitions of the surfaces associated with these textures. In some implementations, the volumetric video data structure 226 may include mesh-based or point-based points defining surfaces within the volumetric video, with corresponding texture files indicating color, texture, or materials associated with these surfaces. For example, frames of the volumetric video may include information defining textured meshes. For example, the volumetric video data structure 226 can include triangle meshes (or other polygon meshes) defining the spatial distribution of a surface in space, where the texture includes information relating to the visual or physical attributes of the given surface. By generating volumetric videos of humans, the training module 224 can analyze and capture 3D information relating to poses, thereby improving the flexibility of generating training data for a pose estimator—for example, a single volumetric video can capture multiple possible camera angles associated with the human, thereby improving the robustness and usefulness of a single recording or capture of a human.

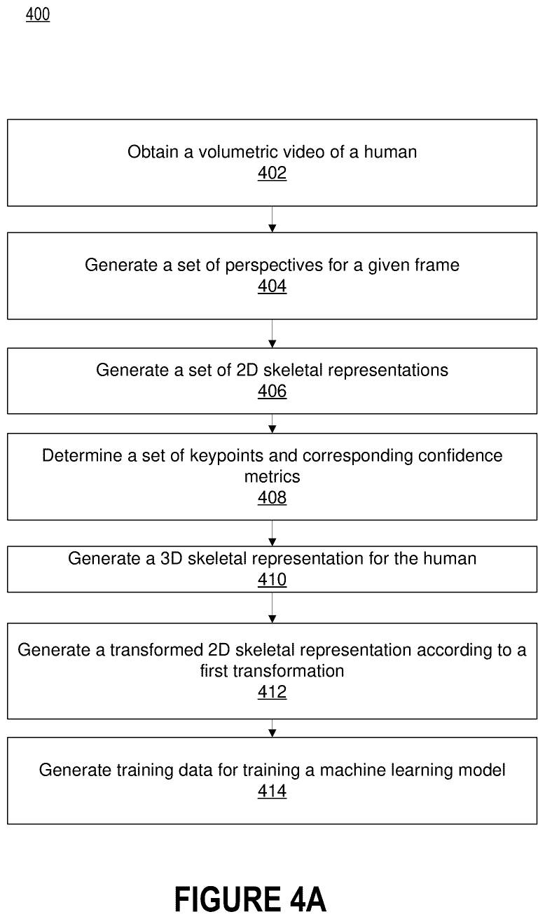

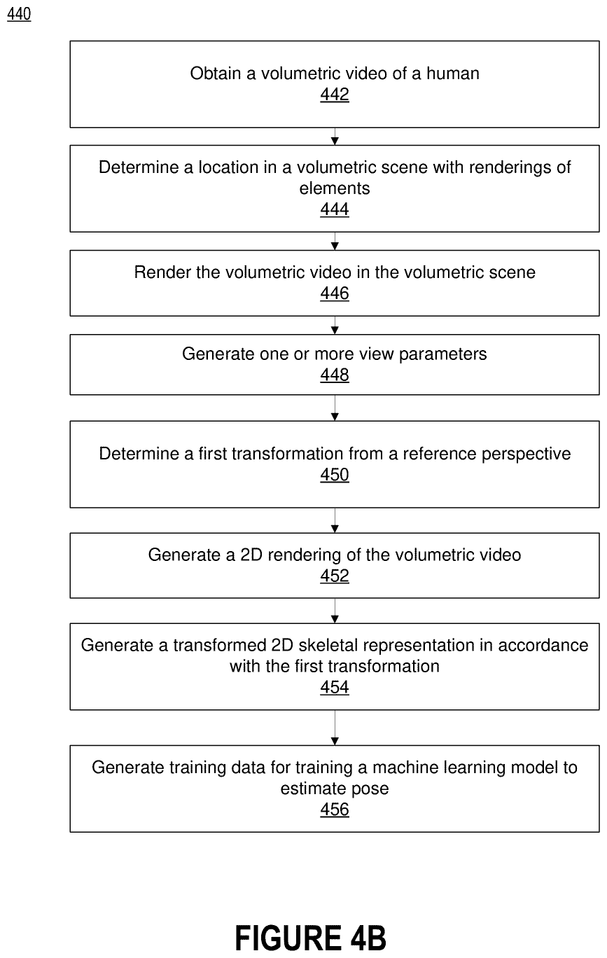

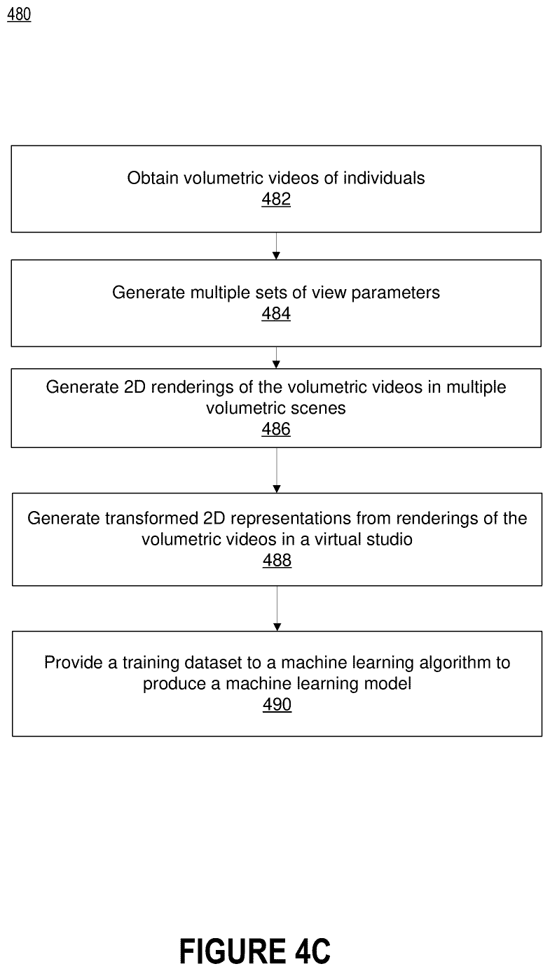

The volumetric video data structure 226 can include information relating to frames of a volumetric video. A frame can include a volumetric capture of a human at a given time during the volumetric video. For example, a frame can include information relating to the 3D spatial distribution of textures within a volumetric video at a particular time. By including time-dependent information relating to a human performing a pose, the volumetric video data structure 226 can include a variety of poses performed by a single user, thereby extending the applicability of a given volumetric video to various users. The training module 224 can leverage the time evolution of frames within the volumetric video data structure 226 to estimate confidence metrics for relevant training data (e.g., for keypoints, as discussed in relation to keypoint triangulation module 234). Furthermore, this time-dependent information within the volumetric video enables the training module 224 to improve the quality of training data generated thereof based on temporal filtering, as discussed in relation to keypoint triangulation module 234 and FIG. 4A below.

The training module 224 can leverage the volumetric video data structure 226 and the virtual studio module 230 to generate synthetic ground truth data for the training data structure 236. For example, the virtual studio module 230 can include processes, operations, and data structures associated with generating skeletal representations of poses being performed by humans of volumetric videos. A virtual studio may include a 3D visual representation of surfaces associated with a volumetric video with a clearly visible background. For example, a virtual studio may include a scene where textures from a volumetric video associated with a human are visible (e.g., against a green background, or background of another color that enables the human to be visible). The training module 224 can remove objects or elements of the volumetric video that are not associated with the human or the human's pose, such as furniture, and extraneous people or objects. As such, by placing the volumetric video in a virtual studio, the training module 224 enables accurate determination of key anatomical landmarks associated with the human in three dimensions for further processing and generation of ground-truth skeletal data to serve as part of training data for a pose estimator.

The virtual studio module 230 can place the volumetric video (e.g., as encapsulated within the volumetric video data structure 226) within the virtual studio. Based on this placement, the training module 224 can generate images associated with the human from various perspectives. A perspective can include an image or representation of the volumetric video and/or a pose (e.g., a skeletal representation) of a human from a direction, angle, or translation. For example, a perspective can include a view or an image of a performed human pose that is visible within a volumetric video, where the view is from a particular direction, location, or angle in space. Such an image can include a 2D projection of the volumetric video in a direction associated with the given perspective. As an illustrative example, a perspective can include a view of a volumetric video of a human performing a yoga pose from behind the human (or another angle), thereby generating the corresponding 2D projection of the human's pose.

By capturing multiple perspectives of the volumetric video, the training module 224 can capture various angles of the volumetric video in order to accurately determine the 3D skeletal structure of the human performing the given pose at the given time, thereby leading to accurate generation of ground-truth training data for estimating the human's pose. For example, the training module 224 can determine a transformation of a reference perspective to another perspective, and apply this transformation to generate both the ground-truth skeletal representation of the human, as well as the corresponding training images, as discussed further. Thus, a perspective in the virtual studio can correspond to a 2D rendering of the volumetric video within a volumetric scene and image (as discussed in relation to the volumetric scene module 232), thereby providing training data that includes multiple views of poses performed by users. As such, the training module 224 may be robust against humans performing poses at new angles to a camera.

The multiple perspectives may be generated based on corresponding virtual camera views. A virtual camera view may include a perspective defined by a location of a theoretical camera within the virtual studio. For example, a virtual camera view may include a distance or a position of the volumetric video (e.g., a centroid position of the volumetric video) in relation to a theoretical camera (e.g., a virtual camera) within the virtual studio. For example, the virtual camera view may include information relating to the field of view (e.g., angles pertaining to the edge of the visible image captured by the virtual camera) for the 2D projection, as well as an angle of the 2D projection with respect to one or more reference axes. The virtual camera view may include view parameters relating to the view of the virtual camera, including the virtual camera's roll, yaw, tilt, and/or field of view with respect to a defined coordinate system within the virtual studio. In some implementations, virtual camera views (and the corresponding generated perspectives) may be selected with respect to a pose to target perspectives or views that are poorly or inaccurately predicted or processed by the pose estimator (e.g., by estimating module 216). Alternatively or additionally, such view parameters can be determined stochastically, such as through the selection of view parameters on the basis of a probability distribution for each or some of the parameters. By doing so, the training module 224 can generate a wide variety of virtual camera perspectives, thereby improving the robustness of the subsequently trained pose estimator to various perspectives of captured human poses.

In some implementations, the system can define the virtual camera views with respect to a reference perspective on the basis of a transformation. A transformation can include indications of angular transformations (e.g., in the angle of a virtual camera's view with respect to a pre-determined access), spatial transformations (e.g., translations of the virtual camera's source view with respect to the virtual studio or volumetric scene's coordinate system), and/or field of view. By defining a transformation with respect to a reference perspective, the training module 224 can correlate ground-truth skeletal data generated on the basis of the volumetric video within the virtual studio with image data generated by placing the volumetric video within a volumetric scene, with corresponding background objects or elements. By doing so, the training module 224 enables packaging of training data for pose estimators (e.g., as used by the estimating module 216).

Based on the generation of various perspectives of the volumetric video within the virtual studio, the training module 224, through keypoint triangulation module 234, may generate such training data, corresponding to 2D and 3D skeletal representations of the human performing the pose. For example, the keypoint triangulation module 234 may generate 2D skeletal representations of the human performing the pose associated with each perspective of the volumetric video in the virtual studio. A 2D skeletal representation may include a representation of anatomical landmarks of a human within a perspective of the volumetric video in the virtual studio. For example, the 2D skeletal representation may include 2D keypoints. Keypoints may include 2D positions corresponding to horizontal and vertical pixel coordinates of anatomical features (e.g., anatomical landmarks), such as joints, eyes, noses, or limbs, within an image corresponding to a virtual camera view of the volumetric video within the virtual studio. The training module 224 may generate these 2D skeletal representations for each frame of the volumetric video, as well as for each virtual camera view generated. In some embodiments, each keypoint may be associated with a particular anatomical feature and stored with this association; for example, a particular 2D keypoint may be associated with a right elbow. By doing so, the training module 224 may correlate these keypoints at different times or across different perspectives to generate a 3D skeletal representation of the human.

For example, the training module 224 may determine which anatomical features include keypoints with high confidence by generating confidence metrics associated with keypoints for each of these anatomical features. The training module 224 may determine a confidence metric based on a consistency of the position of a given determined keypoint over various frames of the volumetric video (e.g., a temporal consistency) and, based on this consistency metric, determine a confidence metric for the keypoint. For example, the consistency metric may include a quantitative measure in noise or root-mean-squared deviation of the position of a given keypoint from an expected or average position (e.g., a moving average position) over time. The confidence metric may include a quantitative measure of a confidence in a keypoint for further triangulation and generation of a 3D skeletal representation.

For example, the keypoint triangulation module 234 may calculate weights associated with the keypoints based on their corresponding confidence metrics (e.g., by dividing each confidence metric associated with a keypoint with the sum of all such confidence metrics), and may triangulate these keypoints to generate the 3D skeletal representation of the human on the basis of these weights. By doing so, the training module 224 may generate more accurate, less noisy skeletal representations of the humans, thereby improving the quality of ground-truth data associated with the volumetric video.

Based on these 2D keypoints corresponding to different perspectives of the volumetric video within the virtual studio, the keypoint triangulation module 234 may triangulate a 3D skeletal representation of the human performing a pose in the volumetric video. For example, the keypoint triangulation module 234 may prioritize 2D keypoints (and, e.g., the corresponding anatomical landmarks) with high confidence metrics more than those with lower confidence metrics to generate a set of 3D keypoints representing the human's pose in 3D on the basis of the various 2D keypoints. For example, 3D keypoints may include 3D coordinates of positions indicating the corresponding anatomical landmarks in a 3D coordinate system associated with the virtual studio, for example. By doing so, the training module 224 may obtain a representation of the human's pose at a given time in the volumetric video that may be transformed to any necessary view or perspective corresponding to training data generated within the volumetric scene (as described below).

For example, the training module 224 may transform the 3D skeletal representation (e.g., comprising 3D keypoints of the user) according to a transformation and capture the 2D projection of this 3D skeletal structure from a perspective or camera view associated with this transformation. By doing so, the training module may relate the given 2D projection of the 3D skeletal representation (e.g., a transformed 2D skeletal representation) to a corresponding 2D rendering of the volumetric video with a customized background and/or simulated camera characteristics, thereby providing ground-truth data associated with training data.

In some implementations, the keypoint triangulation module 234 may utilize temporal filtering to improve the quality of 2D keypoint and 3D keypoint data. For example, the keypoint triangulation module 234 may filter out temporal frequencies associated with noise (e.g., small, frequent variations over time), thereby smoothening out the estimates of keypoint positions. As such, the training module 224 may obtain more accurate information relating to the positions of anatomical features associated with a human in the volumetric video. Thus, the training module 224 obtains more accurate ground-truth data for training the pose estimator.

The training data (e.g., as stored in the training data structure 236) may include images generated using the volumetric scene module 232. The volumetric scene module 232 may generate 2D and/or 3D renderings of the volumetric video within a scene with various other elements, backgrounds, or characteristics, for generation of synthetic training data for pose estimation. For example, the volumetric scene module 232 may place the volumetric video (e.g., as stored within the volumetric video data structure 226) within a volumetric scene. The volumetric scene may include renderings (e.g., volumetric images or videos) of other elements, which may include as walls, backgrounds, furniture, or other objects. Such elements may include volumetric videos or images, including textures, surfaces, and 3D renderings (e.g., 3D representations, as in the form of a corresponding volumetric video) of such elements within a virtual studio. For example, the training module 224 may generate the volumetric scene by generating the volumetric video of a human within a virtual studio that includes volumetric images or videos of these elements. By doing so, the system may generate various images of the human performing poses from different perspectives, and under different circumstances, thereby improving the quantity of training data, while enabling the training module 224 to focus on aspects of the pose estimator that may require further training for accurate pose estimation.

In some implementations, the volumetric scene module 232 may place a 3D rendering of the volumetric video (e.g., the volumetric video itself) at a determined location. A location may include positional coordinates within the volumetric scene, such as two horizontal coordinates (e.g., an x and a y coordinate) and a vertical coordinate (e.g., a z coordinate). For example, the training module 224 may determine a candidate location for potentially placing a centroid position of the volumetric video within the volumetric scene (e.g., a position corresponding to a location of the human). The candidate location may be determined stochastically or randomly (e.g., according to a probability distribution). The training module 224 may determine whether the volumetric video, when placed at this candidate location within the volumetric scene, is interfering with, blocking, or interacting with elements in the volumetric scene. In this case, the volumetric scene module 232 may vary or determine another candidate location for the volumetric video within the volumetric scene to ensure high-quality renderings of the volumetric video within the volumetric scene.

Based on generating the volumetric scene, the volumetric scene module 232 enables 2D renderings of the volumetric video. For example, a 2D rendering of the volumetric video may include an image or another 2D representation of a volumetric video of a human performing a pose, in addition to any elements included within the volumetric scene. For example, the 2D rendering may include an image of the volumetric vide of the human performing the pose with a particular set of elements, and with a particular simulated set of lighting conditions or capture conditions emulating a corresponding virtual camera taking the same image. For example, the 2D rendering of the volumetric video can include an image of the volumetric scene including the volumetric video, where the 2D rendering includes a particular hue (e.g., sepia), image quality, simulated lighting condition (e.g., a direction of incident light) and perspective/virtual camera view (as described previously). By doing so, the training module 224 enables generation of various views of human poses from various perspectives under various conditions, thereby improving the robustness and range of training data produced for the pose estimator.

The training module 224 may be used to train machine learning models associated with pose estimation (e.g., a pose estimator, as relating to the estimation module 216). For example, the training module 224 may extract one or more feature maps from image or video data associated with a user performing a pose (or, in some implementations, from the volumetric video data). In one embodiment, the training module 224 segments texture image data or volumetric video data into contiguous regions of pixels. Each contiguous region of pixels may be associated with a portion of the environment. In some embodiments, the training module 224 segments the texture data based on objects shown in the image data. The term “feature map” may be used to refer to a vectorial representation of features in the volumetric video data structure 226 and/or image or video data extracted from a human's video during the performance of a pose. The training module 224 may extract feature maps by applying filters or feature detectors to each segment. The training module 224 may store the segments and associated feature maps in the volumetric video data structure 226 or another datastore.

The training module 224 can apply a machine learning model (e.g., the neural network 228) to each extracted feature map. In some implementations, one or more neural networks (e.g., the neural network 228) are common to other modules, such as the estimating module 216. The neural network 228 may include a series of convolutional layers and a series of connected layers of decreasing size and the last layer of the neural network 228 may be a sigmoid activation function. The neural network 228 can include a plurality of parallel branches that are configured to together estimate poses of body parts based on the feature maps. Alternatively or additionally, the neural network 228 can include a plurality of parallel branches that are configured to together estimate keypoints (e.g., skeletal positions) of anatomical landmarks within a volumetric video associated with body parts of a human. A first branch of the neural network 228 could be configured to determine a likelihood that the portion of the environment associated with the segment includes a body part, while a second branch of the neural network 228 could be configured to determine an estimated pose of the body part in the portion of the environment associated with the segment. In some embodiments, the body pose module 224 may employ an additional or alternative machine-learning or artificial intelligence framework to the neural network 228 to estimate poses of body parts.

In some embodiments, the neural network 228 may include additional or alternative branches that the body pose module 224 employs together to determine a pose or an anatomical landmark (e.g., a keypoint) of a body part. For example, in some embodiments, the neural network 228 includes a set of branches for each possible body part that may be included in the segment. For example, the neural network 228 may include a set of hand branches that determine a likelihood that the segment includes a hand and estimated poses of hands in the segment. The neural network may similarly include a set of branches that detect right legs in the segment and determine poses of the right legs in the segment and another set of branches that detects and determines poses of left legs in the segment. Further, the neural network 228 may include branches for other anatomical regions (e.g., elbows, fingers, neck, torso, upper body, hip to toes, chest and above, etc.) and/or sides of a user's body (e.g., left, right, front, back, top, bottom). The neural network is further described below.

For example, the neural network 228 can generate estimated keypoints, skeletal representations, or estimated poses (e.g., through estimating module 216) using one or more machine learning models designed and trained for pose estimation and/or keypoint generation (also called “pose estimation models,” “pose estimators,” or simply “models”), which can include the neural network 228 or any other neural network, artificial intelligence, or computer-based analytical method. For example, a machine learning model can be any software or hardware tool that can learn from data and make predictions, classifications, or inferences based on this data. In some embodiments, the machine learning model can include one or more algorithms, including supervised learning, unsupervised learning, semi-supervised learning, reinforcement learning, deep learning, neural networks, decision trees, support vector machines, and k-means clustering. For example, the machine learning model can be implemented as a convolutional neural network (or feed forward network, recurrent neural network, random forest, or xgboost model). The machine learning model can include any model that can accept, for example, one or more digital images and/or video frames as input. The machine learning model can infer a two-dimensional (“2D”) or three-dimensional (“3D”) representation of the pose of one or more users, for example, through the body pose module 224 and/or other similar techniques disclosed above.

The one or more machine learning models utilized by the estimating module 216 or the training module 224 can be trained, such as through the training module 232 using the training data structure 236 (as discussed below), to execute inference operations. An inference operation can include an operation that accepts input (e.g., a digital image) and outputs a classification, a prediction, a score, or a dataset. In disclosed embodiments, an inference operation can output one or more datapoints that define an estimated pose, such as a 2D or a 3D representation of a user's body parts within a digital image. In some embodiments, an inference operation can include generation of a numerical score indicating confidence in an estimated pose by a real-time or background confidence determination model (e.g., a likelihood that the estimated pose corresponds to an actual pose of the user). For example, a machine learning model that is executing an inference operation can include a real-time or background confidence determination model, which can receive a digital image and a representation of an estimated pose as input and generate a probability that the first estimated pose corresponds to the actual pose of the user as output.

Machine learning models can include model parameters. A model parameter can include variables (including vectors, arrays, or any other data structure) that are internal to the model and whose value can be determined from training data. For example, model parameters can determine how input data is transformed into the desired output. As an illustrative example, in the case of a machine learning model leveraging the neural network 228, model parameters can include weights or biases for each neuron within each layer. In some embodiments, the weights and biases can be processed using activation functions for corresponding neurons, thereby enabling transformation of the input into a corresponding output. Model parameters can be determined using one or more training algorithms, such as those executed by the training module 232, using training data within the training data structure 236, as discussed below. For example, model parameters for models associated with the estimating module 216 can be trained or generated based on training data pertaining to many users or humans of the motion monitoring platform 212. Additionally or alternatively, local versions of the machine learning model can include model parameters that are trained on data pertaining to a particular human, and/or can include various perspectives, circumstances or conditions imposed upon a volumetric video of the given human. For example, training data stored in the training data structure 236 may include a 2D rendering of the volumetric video, as described above, as well as a corresponding transformed 2D skeletal representation, where both correspond to the same transformation or perspective. By generating such training data, the motion monitoring platform 212 can provide improved estimated poses that are more sensitive to various characteristics and/or environments.

For example, the machine learning model may be used to evaluate the performance of a human performing a pose. The system may obtain a video of a user (e.g., a human) and, based on providing images from the video or the video itself to the pose estimator (e.g., the machine learning model), the motion monitoring platform may determine an evaluation metric for the user characterizing how well the user performed an expected or desired pose (e.g., characterizing a performance of the intended pose). In some implementations, the system may generate further feedback associated with the user.

Other modules could also be included in some embodiments. For example, the motion monitoring platform 212 may include a template generating module (not shown) that is responsible for generating templates that are used by the analysis module 218 to determine which recommendations, if any, are appropriate for a user given her current position.

Similarly, other components could be implemented in, or accessible to, the computing device 200 in some embodiments. For example, some embodiments of the computing device 200 include an audio output mechanism and/or an audio input mechanism (not shown). The audio output mechanism may be any apparatus that is able to convert electrical impulses into sound. Meanwhile, the audio input mechanism may be any apparatus that is able to convert sound into electrical impulses. Together, the audio output and input mechanisms, may enable feedback, such as personalized recommendation as further discussed below, to be audibly provided to the user.

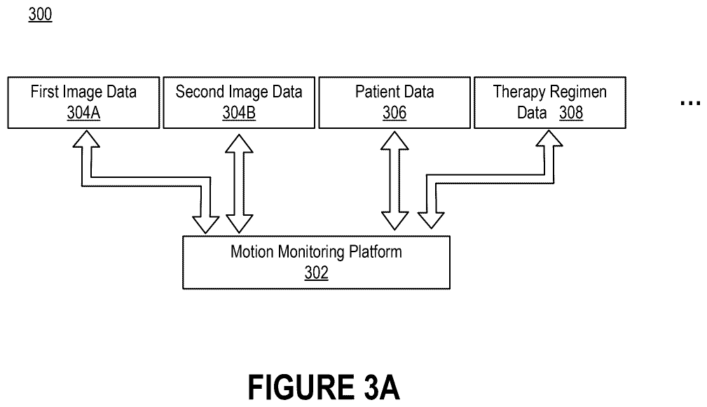

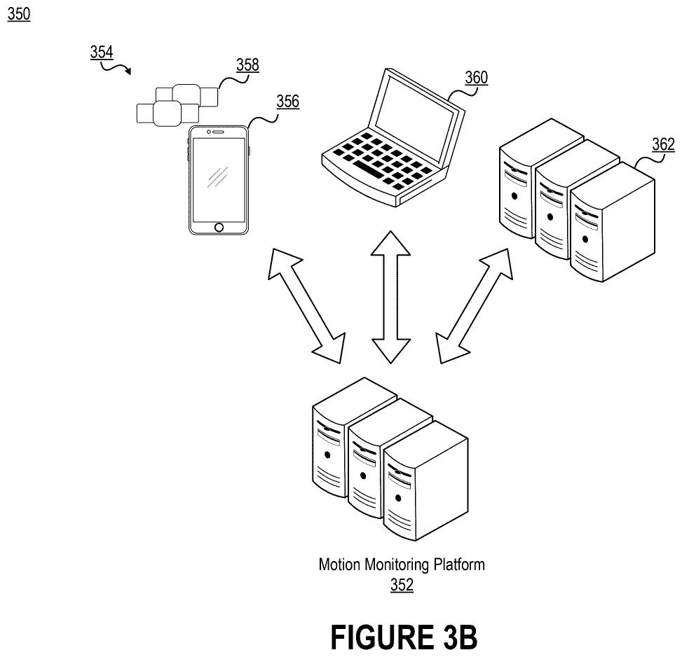

FIG. 3A depicts an example of a communication environment 300 that includes a motion monitoring platform 302 configured to receive several types of data. Here, for example, the motion monitoring platform 302 receives first image data 304A that captured by a first image sensor (e.g., image sensor 210 of FIG. 2A) located in front of a user, second image data 304B generated by a second image sensor located behind a user, user data 306 that is representative of information regarding the user, and therapy regimen data 308 that is representative of information regarding the program in which the user is enrolled. Those skilled in the art will recognize that these types of data have been selected for the purpose of illustration. Other types of data, such as community data (e.g., information regarding adherence of cohorts of users), could also be obtained by the motion monitoring platform 302.

These data may be obtained from multiple sources. For example, the therapy regimen data 308 may be obtained from a network-accessible server system managed by a digital service that is responsible for enrolling and then engaging users in programs. The digital service may be responsible for defining the series of physical activities to be performed during sessions based on input provided by coaches. As another example, the user data 306 may be obtained from various computing devices. For instance, some user data 306 may be obtained directly from users (e.g., who input such data during a registration procedure or during a session), while other user data 306 may be obtained from employers (e.g., who are promoting or facilitating a wellness program) or healthcare facilities such as hospitals and clinics. Additionally or alternatively, user data 306 could be obtained from another computer program that is executing on, or accessible to, the computing device on which the motion monitoring platform 302 resides. For example, the motion monitoring platform 302 may retrieve user data 306 from a computer program that is associated with a healthcare system through which the user receives treatment. As another example, the motion monitoring platform 302 may retrieve user data 306 from a computer program that establishes, tracks, or monitors the health of the user (e.g., by measuring steps taken, calories consumed, or heart rate).

FIG. 3B depicts another example of a communication environment 350 that includes a motion monitoring platform 352 configured to obtain data from one or more sources. Here, the motion monitoring platform 352 may obtain data from a therapy system 354 comprised of a tablet computer 356 and one or more sensor units 358 (e.g., image sensors), personal computer 360, or network-accessible server system 362 (collectively referred to as the “networked devices”). For example, the motion monitoring platform 352 may obtain data regarding movement of a user during a session from the therapy system 354 and other data (e.g., therapy regimen information, models of exercise-induced movements, feedback from coaches, and processing operations) from the personal computer 360 or network-accessible server system 362.

The networked devices can be connected to the motion monitoring platform 352 via one or more networks. These networks can include PANs, LANs, WANs, MANs, cellular networks, the Internet, etc. Additionally or alternatively, the networked devices may communicate with one another over a short-range wireless connectivity technology. For example, if the motion monitoring platform 352 resides on the tablet computer 356, data may be obtained from the sensor units over a Bluetooth communication channel, while data may be obtained from the network-accessible server system 362 over the Internet via a Wi-Fi communication channel.

Embodiments of the communication environment 350 may include a subset of the networked devices. For example, some embodiments of the communication environment 350 include a motion monitoring platform 352 that obtains data from the therapy system 354 (and, more specifically, from the sensor units 358) in real time as physical activities as performed during a session and additional data from the network-accessible server system 362. This additional data may be obtained periodically (e.g., on a daily or weekly basis, or when a session is initiated).

### Process for Generating Ground-Truth Skeletal Representations

FIG. 4A depicts a flow diagram of a process for generating labelled skeletal representations for training a machine learning model to estimate pose. For example, flow 400 enables the training module 224 to generate estimates of anatomical landmarks of a human from a volumetric video of the human, which may be transformed to correspond to a rendering of the volumetric video in a simulated scene. By doing so, the training module 224 enables generation of training data for training a pose estimator associated with the motion monitoring platform 212 to generate recommendations, feedback, or evaluations of humans performing poses.

At operation 402 (e.g., using one or more components described above), the training module 224 may obtain a volumetric video of a human. For example, the training module 224, through communication module 208 of the computing device 200, may obtain a volumetric video of a human, wherein the volumetric video includes a set of frames, each of which includes a textured mesh representing the human at a corresponding one of a set of times. As an illustrative example, the training module 224 may obtain a volumetric video data structure 226 that includes information relating to textures and spatial distributions of surfaces corresponding to a human performing a pose. By doing so, the training module 224 may further process the volumetric video to simulate scenes of the human performing the pose under a variety of conditions. Moreover, the training module 224 may process the same video to generate a skeletal representation of anatomical features within the volumetric video in order to determine the pose of the human during the same frame. Thus, the training module 224 enables generation of training data for training a pose estimator to estimate skeletal representations corresponding to poses performed by humans in videos or images under a variety of conditions.

At operation 404 (e.g., using one or more components described above), the training module 224 may generate a set of perspectives for a given frame. For example, the training module 224 can utilize the virtual studio module 230 to generate a set of perspectives for a given frame of the set of frames in a virtual studio, wherein the given frame includes a given textured mesh at a given time, and wherein each perspective of the set of perspectives includes a two dimensional (2D) projection of the given frame from a corresponding one of a set of virtual camera views. As an illustrative example, the virtual studio module 230 may place the volumetric video in a virtual environment with a background that enables the volumetric video pertaining to features of interest (e.g., a human performing a pose) to be easily visible and processable. The virtual studio module 230 may capture various views of this volumetric video within the virtual studio in order to capture different perspectives of the human pose, to improve the training module 224's information relating to the nature of the human pose in three dimensions. By doing so, the training module 224 prepares an environment where further analysis of the human's poses over frames of the volumetric video may be determined accurately.

In some embodiments, the virtual studio module 230 may generate the perspectives based on a variety of virtual camera angles, including roll, yaw, and tilt. For example, the virtual studio module 230 may determine the set of virtual camera views, wherein each virtual camera view comprises:
(i) a first virtual camera angle, indicating an angle of virtual camera roll,
(ii) a second virtual camera angle, indicating an angle of virtual camera yaw, and
(iii) a third virtual camera angle, indicating an angle of virtual camera tilt;

Furthermore, the virtual studio module 230 can determine or set the reference perspective to include one of the set of virtual camera views. By doing so, the training module 224 defines, relative to a coordinate system, the attributes associated with different perspectives of the volumetric video, thereby enabling correlation between the pseudo-ground-truth 3D skeletal representation of the human and perspectives of the corresponding simulated volumetric scene.

At operation 406 (e.g., using one or more components described above), the training module 224 may generate a set of 2D skeletal representations for the set of perspectives. For example, the virtual studio module 230 (e.g., through the neural network 228) may generate lines or 2D positions corresponding to anatomical features of the human performing the pose within each perspective of the volumetric video in the virtual studio. The virtual studio module 230 may generate lines corresponding to limbs, facial features (e.g., eyes, noses, or mouths), or other anatomical attributes, thereby generating 2D skeletal representations of the human (e.g., at each perspective, and at each frame in the volumetric video). By doing so, the training module 224 prepares the volumetric video data in such a way as to generate or estimate the pose of the human at a given frame, based on skeletal representations of the human projected in 2D from various perspectives or angles.

In some embodiments, the virtual studio module 230 may improve the accuracy of the 2D skeletal representations based on temporal filtering. For example, the virtual studio module 230 may, for each frame of the multiple frames, generate a set of 2D positions for the set of perspectives, so as to generate multiple sets of 2D positions. The virtual studio module 230 may filter frequencies of the multiple sets of 2D positions to smoothen temporal variations in the set of 2D positions. For each perspective of the set of perspectives, the virtual studio module 230 may generate the set of 2D skeletal representations based on corresponding filtered frequencies of the set of 2D positions for the given frame. For example, the virtual studio module 230 may employ a low-pass temporal filtering algorithm to reduce the noise (e.g., high-frequency variations) in estimates in positions of the human's limbs, as such quick movements may not be indicative of the human's movement, but rather of imprecision or accuracy errors in the determination of the human's skeletal structure.

At operation 408 (e.g., using one or more components described above), the training module 224 may determine a set of keypoints and corresponding confidence metrics. For example, the virtual studio module 230 may determine (i) a set of keypoints corresponding to different anatomical landmarks across the set of 2D skeletal representations and (ii) confidence metrics for the set of keypoints. The virtual studio module 230 may determine anatomical features (e.g., landmarks) that accurately define the pose of the human associated with the volumetric video, such as joints, or connections between limbs, or the spinal structure, and define these keypoints in 2D for each perspective. Furthermore, in some embodiments, the virtual studio module 230 may generate confidence metrics for each of these keypoints (e.g., for each of these anatomical features) across all perspectives, thereby enabling the training module 224 to weigh keypoints that have higher confidence more heavily when generating the estimated human pose for the given frame of the volumetric video.

In some embodiments, the virtual studio module 230 may determine the confidence metrics based on consistency of the estimated keypoints over time. For example, the virtual studio module 230 may generate a consistency metric for each keypoint of the set of keypoints, wherein the consistency metric indicates a measure of temporal consistency over the set of frames for a corresponding keypoint of the set of 2D skeletal representations. The virtual studio module 230 may generate, based on the consistency metric, a confidence metric for the corresponding keypoint. As an illustrative example, the virtual studio module 230 may determine that a given keypoint corresponding to a given anatomical landmark (e.g., a right elbow) fluctuates in position wildly across multiple frames of multiple perspectives of the volumetric video. By determining a consistency metric that characterizes this fluctuation (e.g., a root-mean-square fluctuation in the positional coordinates of the given keypoint), the virtual studio module 230 may quantify a corresponding confidence metric for the given keypoint, thereby enabling the training module 224 to weight keypoints that are more likely to be accurate more heavily in determining the 3D skeletal structure of the human, as described below.

At operation 410 (e.g., using one or more components described above), the training module 224 may generate a 3D skeletal representation for the human. For example, the training module 224 may determine, based on the confidence metrics, a three-dimensional (3D) skeletal representation for the human. As an illustrative example, the keypoint triangulation module 234 may utilize information corresponding to a given perspective, as well as information relating to the confidence of the keypoints associated with the corresponding 2D skeletal representation, in order to generate an estimate of the 3D human pose (e.g., 3D skeletal representation) of the human at that given frame in time. For example, the keypoint triangulation module 234 may weight anatomical landmarks (e.g., keypoints) heavier for the anatomical landmarks for which confidence in the positions across the various perspectives is greater. The keypoint triangulation module 234 may leverage information relating to the set of perspectives (e.g., the parameters associated with virtual camera views) to combine the various perspectives and 2D skeletal representations for a given frame to generate the 3D skeletal representation. By doing so, the training module 224 obtains accurate information relating to the skeletal structure and, therefore, pose, of the human in the volumetric video. Furthermore, because this representation is in three dimensions, the training module 224 may manipulate this 3D skeletal representation (e.g., rotate, translate, or transform) to fit simulated training images or videos generated from the same volumetric video, thereby improving the quality of training data for the pose estimator.

In some embodiments, the virtual studio module 230 or the keypoint triangulation module 234 may generate the 3D skeletal representation based on temporal filtering to reduce spurious variations in the estimated pose of the human (some of which may be physically impossible). For example, the keypoint triangulation module 234 may generate, based on the set of keypoints, a set of 3D skeletal representations corresponding to the set of frames. The system may filter frequencies of each 3D skeletal representation to generate a temporally filtered 3D skeletal representation for each frame of the set of frames. The system may generate the 3D skeletal representation for the human based on filtered frequencies for each 3D skeletal representation for the given frame. As described in relation to operation 404, the virtual studio module 230 may employ a low-pass temporal filter on the 3D positions associated with the 3D skeletal representation in order to reduce estimates of the human's pose that may not be physically possible or are, at least, unlikely (e.g., due to estimated quick movements that are unlikely). By doing so, the training module 224 may improve the accuracy of the synthetic ground-truth data associated with the training data.

In some embodiments, the keypoint triangulation module 234 may weigh keypoints associated with higher confidence metrics more heavily than those associated with lower confidence metrics, thereby improving the accuracy of the estimates of the 3D skeletal representation. For example, the keypoint triangulation module 234 may generate weights, for the set of keypoints, corresponding to the confidence metrics. The virtual studio module 230 may triangulate, in accordance with the weights, a set of 3D keypoints corresponding to the set of keypoints, wherein keypoints of the set of keypoints with greater weights are prioritized over keypoints with smaller weights. The virtual studio module 230 may generate the 3D skeletal representation for the human based on the set of 3D keypoints. As an illustrative example, during the triangulation process, the keypoint triangulation module 234 may supply (e.g., to a neural network 228 carrying out the triangulation process) normalized weights associated with the confidence metrics for each keypoint. By doing so, the training module 224 may improve the accuracy of the determination of the 3D skeletal representation of the human performing the pose by focusing on keypoints that are likely to be more accurate.

At operation 412 (e.g., using one or more components described above), the training module 224 may generate a transformed 2D skeletal representation according to a first transformation. For example, the volumetric scene module 232 may generate a transformed 2D skeletal representation according to a first transformation of the 3D skeletal representation from a reference perspective of the volumetric video to another perspective of the volumetric video. As an illustrative example, as discussed in relation to FIG. 4B, the volumetric scene module 232 may place the same volumetric video in a 3D scene with simulated conditions (e.g., including other elements, such as furniture or backgrounds, as well as custom lighting conditions or photography conditions) and generate multiple views from this 3D scene according to various transformations (e.g., angles) from a reference view. The training module 224 may utilize these transformations to generate 2D projections of the 3D skeletal structure for the given frame according to these same transformations, such that the 2D projection of the 3D skeleton corresponds to the same view as in the simulated 3D scene. By doing so, the training module 224 may generate synthetic training data for the pose estimator and subsequently label this training data by leveraging the generated 3D representations of the same human from the same volumetric video across the various frames.

At operation 414 (e.g., using one or more components described above), the training module 224 may generate training data for training a machine learning model. For example, the training module 224 may generate training data for training a machine learning model to estimate pose, wherein the training data includes (i) the transformed 2D skeletal representation and (ii) a corresponding 2D rendering of the volumetric video. As an illustrative example, the training module 224 may determine frames in time associated with the transformed 2D skeletal representations, as well as the 2D renderings of the volumetric video generated from the volumetric scene (e.g., the 3D scene with simulated conditions), and store this data corresponding to the same frames together in a data structure, thereby generating synthetic training data for training a pose estimator to estimate poses in a variety of conditions.

In some embodiments (e.g., as described in greater detail in relation to FIG. 4B), the training module 224 may generate simulated training data based on placing the same volumetric video in a volumetric scene and capturing this scene according to simulated conditions. For example, the training module 224 may render the volumetric video in a volumetric scene that includes 3D renderings of elements. The training module 224 may generate the corresponding 2D rendering of the volumetric video in the volumetric scene, wherein the corresponding 2D rendering of the volumetric video is from the other perspective. By generating simulated training data based on placing the rendering of the volumetric video in the volumetric scene (e.g., with other objects, or with other lighting conditions), the training module 224 enables generation of synthetic training data by relating these simulated 2D renderings of the volumetric video with the 3D skeletal representation of the human performing the pose, as estimated more accurately through the virtual studio.

### Process for Generating Simulated 2D Renderings of the Volumetric Video

FIG. 4B depicts a flow diagram of a process for generating two-dimensional (2D) renderings of volumetric videos for generation of training data for the machine learning model. For example, flow 440 may be used to generate simulated training data based on the volumetric video, where the simulated training data includes a human performing a pose under various circumstances, perspectives, backgrounds, or conditions. For example, the training module 224 may generate simulated scenes in which objects, backgrounds, or lighting conditions are different, thereby improving the robustness of a pose estimator trained on such conditions.

At operation 442 (e.g., using one or more components described above), the training module 224 may obtain a volumetric video of a human. For example, training module 224 (e.g., through the communication module 208 shown in FIG. 2A) may obtain a volumetric video of a human, wherein the volumetric video includes textured meshes representing the human. As an illustrative example, the volumetric video may include an indication of textures and surfaces that describe a human performing a pose (e.g., a yoga pose). By receiving such information, the training module 224 may process the volumetric video to generate synthetic training data based on placing this volumetric video in simulated scenes.

At operation 444 (e.g., using one or more components described above), the training module 224 may determine a location in a volumetric scene with 3D renderings of elements. For example, the training module 224, through the volumetric scene module 232, may generate coordinates for placing the volumetric video in a scene with 3D renderings of other objects or elements represented through surface textures, such as simulated furniture, backgrounds, walls, or objects. By doing so, the training module 224 may determine how to construct a simulated scene for generating training data based on the volumetric video.

In some embodiments, the volumetric scene module 232 may determine a location for placing the volumetric video within the volumetric scene only where the volumetric video would not interfere with the elements of the volumetric scene. For example, the volumetric scene module 232 may generate a candidate location for the volumetric video in the volumetric scene. The volumetric scene module 232 may render the volumetric video at the candidate location in the volumetric scene. The volumetric scene module may determine that the volumetric video, rendered at the candidate location, and the 3D renderings of elements do not overlap within the volumetric scene. As an illustrative example, in situations where the volumetric scene, if placed at a particular location, would cut through elements of the background in the volumetric scene (e.g., a wall, or an object), the volumetric scene module 232 may recalculate a location for placement, to ensure that any generated scenes are realistic.

In some embodiments, the location of placement of the volumetric video within the volumetric scene may be probabilistically (e.g., stochastically) generated. For example, the volumetric scene module 232 may determine probability distributions for components of positional coordinates in the volumetric scene. The volumetric scene module 232 may stochastically determine, based on the probability distributions, (i) a first horizontal coordinate, (ii) a second horizontal coordinate, and (iii) a vertical coordinate. The volumetric scene module 232 may determine the location in the volumetric scene to include a position corresponding to the first horizontal coordinate, the second horizontal coordinate, and the vertical coordinate. As an illustrative example, the volumetric scene module 232 may determine a range of locations within the 3D space of the volumetric scene where there may be a probability distribution for placing the volumetric video. By choosing a location for the placement of the volumetric video (e.g., a centroid position for the volumetric video of the human performing the pose), the volumetric scene module 232 may generate a variety of placements of the human within the scene, thereby enabling generation of a variety of training data for a pose estimator.

At operation 446 (e.g., using one or more components described above), the training module 224 may render the volumetric video in the volumetric scene. For example, the volumetric scene module 232 may render the volumetric video in the volumetric scene such that the textured meshes are placed at the location in the volumetric scene. As an illustrative example, the volumetric scene module 232 may place the volumetric video of a human performing a pose in a location where other elements, such as simulated furniture or walls, may be visible; by doing so, the training module 224 may construct a simulated scene with a diverse variety of elements in it in order to improve the robustness of the motion monitoring platform to changes in background or scene conditions when evaluating a user performing a pose.

At operation 448 (e.g., using one or more components described above), the training module 224 may generate one or more view parameters for a virtual camera of the volumetric scene. For example, the volumetric scene module 232 may generate various perspectives or angles for the constructed volumetric scene (with the volumetric video and any other elements). In some embodiments, the view parameters may include lighting conditions or camera conditions, including fields of view, color filters, or sources of light. By determining such view parameters, the training module 224 may generate a variety of training data based on the volumetric video of a human performing a pose, thereby improving the flexibility and accuracy of a corresponding pose estimator for estimating human poses based on images or videos captured under a similarity variety of conditions.

In some embodiments, the volumetric scene module 232 may determine view parameters for generating the 2D renderings based on simulated parameters of a virtual camera, including field of view, pitch angles, roll angles, and a position of the camera within the volumetric scene. For example, the volumetric scene module 232 may determine, for the virtual camera:
(i) a virtual field of view indicating a solid angle of visible elements,
(ii) a virtual pitch angle, indicating a vertical incline in a virtual camera orientation,
(iii) a virtual roll angle, indicating a longitudinal rotation of the virtual camera orientation; and
(iv) a virtual camera position within the volumetric scene.

As an illustrative example, the volumetric scene module 232, based on these view parameters, may capture the volumetric video of a human performing a pose from a variety of perspectives and conditions. In some embodiments, these view parameters may specify simulated camera parameters, such as exposure times, contrast levels, lens types, or color filters that a real camera may exhibit. By generating view parameters that may simulate the capture of actual poses performed by humans through other devices, the training module 224 enables generation of a variety of training data.

In some embodiments, the volumetric scene module 232 may generate these view parameters stochastically, with the use of probability distributions. For example, the volumetric scene module 232 may determine probability distributions corresponding to (i) fields of view, (ii) pitch angles, (iii) roll angles, and (iv) camera positions. The volumetric scene module 232 may stochastically determine, based on the probability distributions, (i) the virtual field of view, (ii) the virtual pitch angle, (iii) the virtual roll angle, and (iv) the virtual camera position. In some embodiments, the volumetric scene module 232 may generate other view parameters stochastically, such as lighting conditions or simulated camera characteristics. By doing so, the training module 224 may improve the range of training data produced for pose/motion monitoring platforms and the corresponding machine learning models.

At operation 450 (e.g., using one or more components described above), the training module 224 may determine a first transformation from a reference perspective. For example, the volumetric scene module 232 may determine a first transformation from a reference perspective of the volumetric video to another perspective of the volumetric video associated with the one or more view parameters. As an illustrative example, the volumetric scene module 232 may determine the perspective that the view parameters correspond to, where a virtual camera associated with these view parameters corresponds to, for example, the same field of view, roll angle, pitch angle, and yaw angle. Such parameters may be determined in relation to a reference perspective (e.g., as set by the coordinate system of the volumetric scene or virtual studio described in FIG. 4B). By doing so, the training module 224 enables correlation of the ground-truth data (e.g., an estimated actual human pose of the human within the volumetric video) with the corresponding virtual scene being generated within the volumetric studio.

At operation 452 (e.g., using one or more components described above), the training module 224 may generate a 2D rendering of the volumetric video. For example, the training module 224 may generate, based on the one or more view parameters, a two-dimensional (2D) rendering of the volumetric video at a first time. As an illustrative example, the volumetric studio module 232 may capture the volumetric scene from an angle associated with the determined view parameters, thereby simulating images or videos captured by a human attempting a pose and being monitored by the motion monitoring platform 212. By doing so, the training module 224 enables generation of the training data on the basis of conditions, perspectives, or background objects that may influence the accuracy of the pose estimator.

At operation 454 (e.g., using one or more components described above), the training module 224 may generate a transformed 2D skeletal representation in accordance with the first transformation. For example, the training module 224 (e.g., through the virtual studio module 230) may generate, in accordance with the first transformation, a transformed 2D skeletal representation for the first time based on a rendering of the volumetric video in a virtual studio, as described in relation to FIG. 4A. The transformed 2D skeletal representation may be transformed according to the first transformation (e.g., as determined at operation 450).

In some embodiments, the virtual studio module 230 may generate the transformed 2D skeletal representation using generated 3D keypoints from anatomical landmarks associated with the volumetric video (e.g., as placed in a virtual studio), as described in relation to FIG. 4A. For example, the virtual studio module 230 may obtain a 3D skeletal representation for the human, wherein the 3D skeletal representation is based on a set of 3D keypoints corresponding to different anatomical landmarks associated with the volumetric video. The virtual studio module 230 may generate a 2D representation of the 3D skeletal representation from the reference perspective. The virtual studio module 230 may generate the transformed 2D skeletal representation based on transforming, in accordance with the first transformation, the 2D representation of the 3D skeletal representation.

In some embodiments, the virtual studio module 230 may generate the 3D skeletal representation by generating 2D skeletal representations of the human performing the pose, as captured from a variety of perspectives in the virtual studio, as described in relation to FIG. 4A. For example, the virtual studio module 230 may generate a set of perspectives for a given frame of a set of frames in the virtual studio. The virtual studio module 230 may determine a set of 2D skeletal representations for the set of perspectives. The virtual studio module 230 may generate the 3D skeletal representation for the human based on (i) a set of 2D keypoints and (ii) corresponding confidence metrics.

At operation 456 (e.g., using one or more components described above), the training module 224 may generate training data for training a machine learning model to estimate pose. For example, the training module 224 may generate training data for training a machine learning model to estimate pose, wherein the training data includes (i) the transformed 2D skeletal representation and (ii) the 2D rendering of the volumetric video, as described in relation to operation 414 of FIG. 4A. As such, the training module 224 enables generation of training data, correlating the simulated volumetric scene with the corresponding labelled human poses generated in relation to the virtual studio.

### Process for Training and Utilizing the Generated Training Data to Estimate Human Poses

FIG. 4C depicts a flow diagram of a process for training a machine learning model to monitor motion based on generating training data and corresponding skeletal representations. For example, based on the generated training data as described in relation to FIGS. 4A and 4B, the motion monitoring platform 212 may estimate 2D or 3D poses performed by humans from images or videos based on the variety of simulated training data generated based on volumetric videos.

At operation 482 (e.g., using one or more components described above), the training module 224 may obtain volumetric videos of individuals. For example, the training module 224 (e.g., through the communication module 208) may obtain volumetric videos of individuals, wherein each volumetric video includes a series of textured meshes, in temporal order, representing a corresponding one of the individuals over time. As discussed in relation to FIGS. 4A and 4B, such volumetric videos may be utilized to generate synthetic training data for machine learning model (e.g., a pose estimator associated with the motion monitoring platform 212).

At operation 484 (e.g., using one or more components described above), the training module 224 may generate multiple sets of view parameters. For example, the volumetric scene module 232 may generate, for each of multiple virtual cameras in multiple volumetric scenes, a set of view parameters so as to generate multiple sets of view parameters, wherein each set of view parameters is associated with a corresponding one of multiple transformations. As discussed in relation to FIGS. 4A and 4B, such view parameters may be utilized to generate a wide variety of simulated training videos and images for a pose estimator.

In some embodiments, the volumetric scene module 232 generates multiple view parameters, including fields of view, pitch angles, roll angles, and virtual camera positions. For example, the volumetric scene module 232 may determine, for each of the multiple virtual cameras in the multiple volumetric scenes (i) a virtual field of view indicating a solid angle of visible elements, (ii) a virtual pitch angle, indicating a vertical incline in a virtual camera orientation, (iii) a virtual roll angle, indicating a longitudinal rotation of the virtual camera orientation, and (iv) a virtual camera position within a corresponding one of the multiple volumetric scenes, as discussed in relation to FIG. 4B.

In some embodiments, the volumetric scene module 232 generates these view parameters stochastically. For example, the volumetric scene module 232 may determine, for each of the multiple virtual cameras in the multiple volumetric scenes, probability distributions corresponding to (i) fields of view, (ii) pitch angles, (iii) roll angles, and (iv) camera positions so as to generate multiple sets of probability distributions. The volumetric scene module 232 may stochastically determine, based on each one of the multiple sets of probability distributions and for each of the multiple virtual cameras in the multiple volumetric scenes, (i) the virtual field of view, (ii) the virtual pitch angle, (iii) the virtual roll angle, and (iv) the virtual camera position, as discussed in relation to FIG. 4B.

At operation 486 (e.g., using one or more components described above), the training module 224 may generate 2D renderings of the volumetric videos in multiple volumetric scenes. For example, the volumetric scene module 232 may generate, based on the multiple sets of view parameters, two-dimensional (2D) renderings of the volumetric videos in the multiple volumetric scenes. As discussed in relation to FIGS. 4A and 4B, the 2D renderings may include synthetic representations of individuals within the volumetric videos under a variety of simulated conditions, including with objects in the background of the scenes, varied lighting conditions, or varied perspectives.

At operation 488 (e.g., using one or more components described above), the training module 224 may generate transformed 2D representations of the volumetric videos. For example, the virtual studio module 230 may generate, based on the multiple transformations, transformed 2D skeletal representations from renderings of the volumetric videos in a virtual studio, wherein each transformed 2D skeletal representation is related to an associated 2D rendering at an associated time. As discussed in relation to FIGS. 4A and 4B, the training module 224 may thus relate the simulated rendering of the volumetric scene with a corresponding pseudo-ground truth label indicating an accurate estimated pose of the human.

In some embodiments, the virtual studio module 230 may generate the transformed 2D skeletal representations as described in relation to FIG. 4A. For example, the virtual studio module 230 may generate multiple sets of perspectives for frames in the virtual studio, wherein each frame includes a textured mesh at a given time, and wherein each perspective of the multiple sets of perspectives includes a 2D projection of a given frame from a corresponding one of a set of virtual camera views. The virtual studio module 230 may generate sets of 2D skeletal representations for the multiple sets of perspectives. The virtual studio module may generate multiple 3D skeletal representations based on the sets of 2D skeletal representations. The virtual studio module 230 may generate the transformed 2D skeletal representations from the multiple 3D skeletal representations according to the multiple transformations.

In some embodiments, the virtual studio module 230 may generate the 3D skeletal representations based on confidence metrics, as discussed in relation to FIG. 4B. For example, the training module 224 (including the virtual studio module 230 and the keypoint triangulation module 234) may generate sets of 2D keypoints corresponding to anatomical landmarks across the sets of 2D skeletal representations. The training module 224 may determine a confidence metric for each 2D keypoint of the sets of 2D keypoints so as to generate sets of confidence metrics for the sets of 2D keypoints. The training module 224 may triangulate, based on the sets of confidence metrics, sets of 3D keypoints corresponding to the sets of 2D keypoint. The training module 224 may generate the multiple 3D skeletal representations using the sets of 3D keypoints.

At operation 490 (e.g., using one or more components described above), the training module 224 may provide a training dataset to a machine learning algorithm (e.g., through a neural network training algorithm as associated with the neural network 228) to produce a machine learning model (e.g., the pose estimator). For example, the training module 224 may provide a training dataset including the transformed 2D skeletal representations and the 2D renderings to a machine learning algorithm that produces, as output, a machine learning model able to generate 2D estimates of poses based on 2D videos of individuals. As discussed in relation to FIGS. 4A and 4B, the training module 224 thus enables improvements to the accuracy of pose estimation models or motion monitoring models on the basis of synthetically generated training data capturing a variety of conditions, perspectives, and parameters.

In some embodiments, the motion monitoring platform 212 enables poses to be estimated from videos or images of users on the basis of the trained machine learning model (e.g., pose estimator). For example, estimating module 216 may receive a first video of a user over a time period. Estimating module 216 may estimate, based on providing the first video to the machine learning model, a set of 2D skeletal poses for the user over the time period. As an illustrative example, estimating module 216 may receive a video of a user attempting a yoga pose, with multiple types of furniture and with a sepia filter on the user's mobile phone camera, and a rotating camera view. The estimating module may, on the basis of the machine learning model, provide an accurate estimate of the 3D or 2D skeletal pose of the user (e.g., a representation of the skeletal structure of the user superimposed on the image or video over time) based on the model provided. Because the trained machine learning model includes training data with a variety of furniture and lighting conditions, the pose estimator can estimate the pose of the user accurately.

In some embodiments, the motion monitoring platform 212 may evaluate the user on the basis of these estimated poses. For example, the analysis module 218 may generate an evaluation metric for the user, wherein the evaluation metric quantifies a performance of an intended pose for the user. The GUI module 220 may generate, for display on a user interface, instructions for improving the performance of the intended pose. As an illustrative example, the motion monitoring platform 212 thus enables users to receive feedback based on the quality of the estimated skeletal poses in relation to, for example, a reference pose that represents an ideal pose for a user completing a given yoga step. By doing so, the system enables dynamic and accurate feedback for display to a user based on accurate data, even if the user is in an environment with unusual lighting conditions or background objects.

### Environment and Process for Training Data Generation

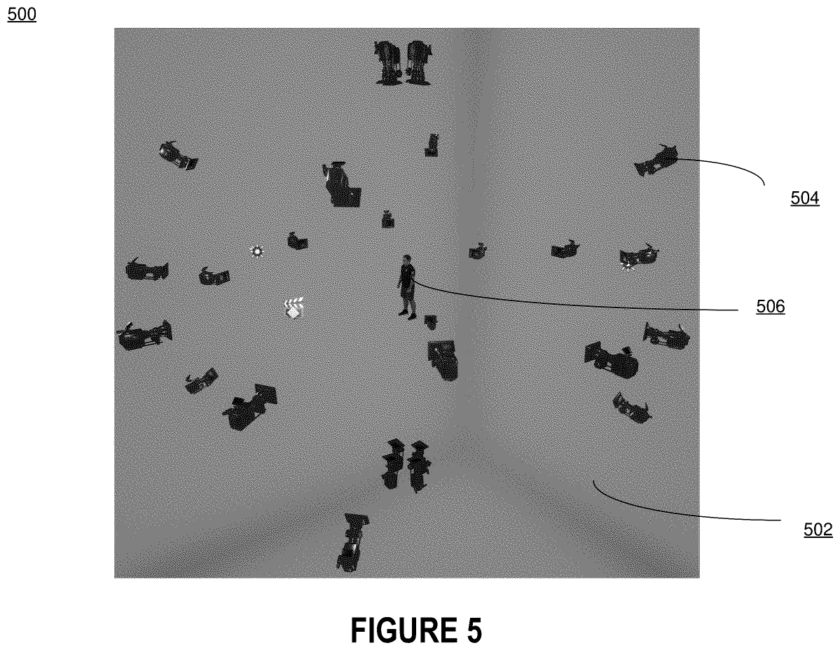

FIG. 5 depicts an example of a virtual studio, in accordance with one or more embodiments. For example, schematic 500 shows an example of a virtual multi-camera capture studio to triangulate keypoints to infer high accuracy 3D poses from volumetric captured persons. For example, schematic 500 includes a virtual studio 502 with a set of virtual cameras 504 at different views capturing a human 506 performing a pose.

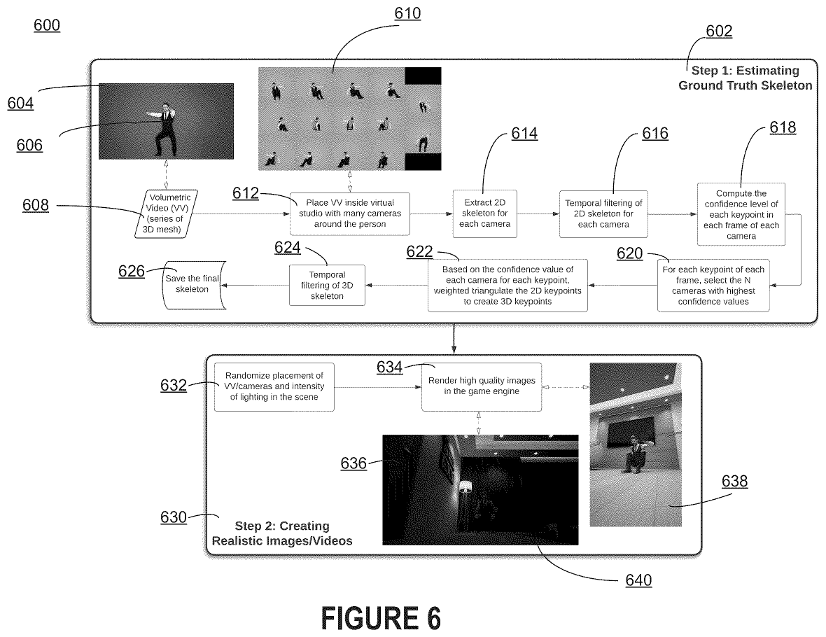

FIG. 6 depicts a flowchart 600 for estimating a ground truth skeleton and realistic images and videos. For example, flowchart depicts step 602 for estimating a ground truth skeleton corresponding to the volumetric video, as well as step 630 for generating the corresponding realistic videos or images from a virtual studio environment.

At step 608, the training module 224 may obtain a volumetric video of a human 606 performing a pose in an environment 604.

At step 612, the training module 224 may place the volumetric video inside a virtual studio with many cameras around the person, as shown in schematic 610.

At step 614, the training module 224 may extract a 2D skeleton for each camera.

At step 616, the training module 224 may execute temporal filtering of the 2D skeleton for each camera.

At step 618, the training module 224 may compute the confidence level of each keypoint in each frame of each camera.

At step 620, the training module 224 may, for each keypoint of each frame, select the N cameras with highest confidence values.

At step 622, based on the confidence value of each camera for each keypoint, the training module 224 may generate a weighted triangulation of the 2D keypoints to create 3D keypoints.

At step 624, the training module 224 may execute temporal filtering of the 3D skeleton.

At step 626, the training module 224 may save or store the final skeleton (e.g., within the training data structure 236 shown in FIG. 2B.

Within step 630, the training module 224 may generate simulated scenes with the volumetric video for the generation of training data.

For example, at step 632, the training module 224 may randomize placement of volumetric videos and virtual cameras based on view parameters. Such view parameters may include the intensity of lighting in the scene, or other parameters associated with lighting in the scene and/or simulated characteristics of the camera.

At step 634, the training module 224 may render high quality images in a game engine (e.g., in the volumetric scene) in order to generate training data. For example, the training module 224 may generate 2D renderings 636 or 638.

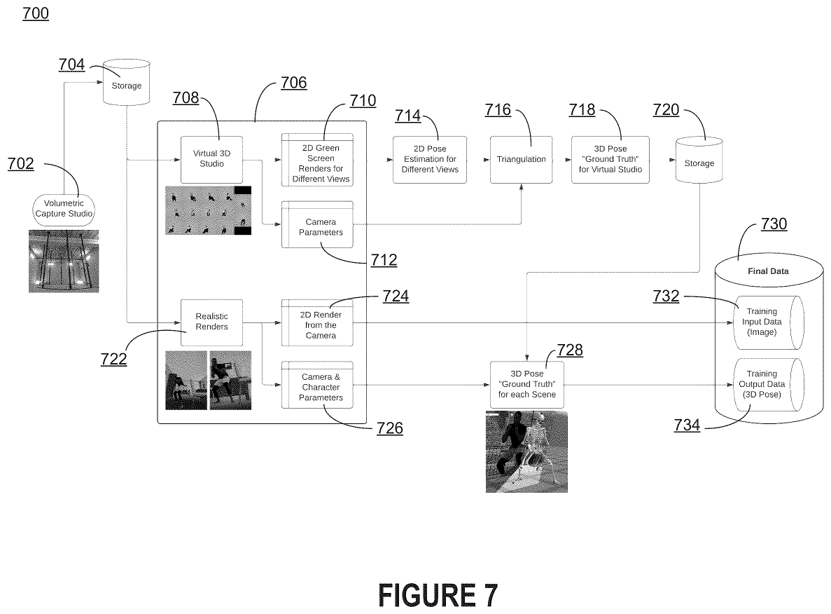

FIG. 7 depicts a flowchart 700 for generating skeletal representations and ground truth scenes based on volumetric video data. For example, the training module 224 may obtain a volumetric video captured in volumetric capture studio 702. The volumetric video may be stored within the storage 704 (e.g., within the motion monitoring platform 212).

At step 706, both pseudo ground-truth 3D skeleton data, as well as realistic renderings of the volumetric video, are generated for training of a pose estimator.

For example, to estimate the pseudo ground-truth 3D skeleton data, at step 708, the training module 224 may place the volumetric video in an empty scene with a green (or another color that is determined to not prominently feature on the volumetric video) screen background.

At step 710, the training module 224 may place multiple virtual cameras around the volumetric video to capture the volumetric video from different views, based on camera parameters 712, for example. One of these views may be selected as a reference view (e.g., a reference perspective) for the keypoint positions.

At step 714, the training module 224 may estimate 2D skeletal positions for each camera view. For example, the training module 224 may filter the 2D skeletal positions temporally (e.g., frequency-wise). For example, the training module 224 may employ a median filter between the previous K frames, current, and future K frames to filter the 2D skeletal positions temporally. The training module 224 may determine a confidence value for each keypoint location for each frame of each camera view

At step 716, the training module 224 may triangulate the keypoints to generate a set of 3D keypoints based on using the confidence values as weights (giving more weight to the 2D keypoints with higher confidence values). For example, the training module 224 may use the camera parameters 712 to mathematically relate various views of the 2D green screen renders and corresponding 2D skeletal structures.

At step 718, the training module 224 may generate the 3D pseudo-ground truth skeletal representation of the human based on the triangulated 3D keypoints. In some embodiments, the training module 224 may filter the 3D positions temporally (e.g., using a median filter between the previous K frames, current, and future K frames). The 3D keypoints/positions may be stored within the storage 720 or the storage 704.

At step 722, the training module 224 may generate realistic renders of the volumetric video within a virtual scene. For example, the training module 224 may render the volumetric video in a random scene, with furniture, a light source, or other variables, factors, or conditions. The volumetric video may be placed in a random location in the scene, but the training module 224 may ensure that the volumetric video does not interfere with any other objects in the virtual scene.

At step 726, the training module 224 may determine camera and character parameters (e.g., field of view, pitch, and roll angle) around the volumetric video in a way that the majority of the volumetric video is visible from each angle.

At step 724, the training module 224 may generate 2D renderings based on this scene and the determined camera/character parameters (e.g., for the frames of the volumetric video, such as for the duration of the volumetric video). These 2D renderings may be stored as training input data (e.g., 3D pose data), as shown in storage 732 within the training data 730.

At step 728, the training module 224 may transform the 3D skeletal representation from the selected virtual camera reference view from the pseudo ground-truth estimation step into the new camera view, which the training module 224 may store in storage 734 within the training data 730.

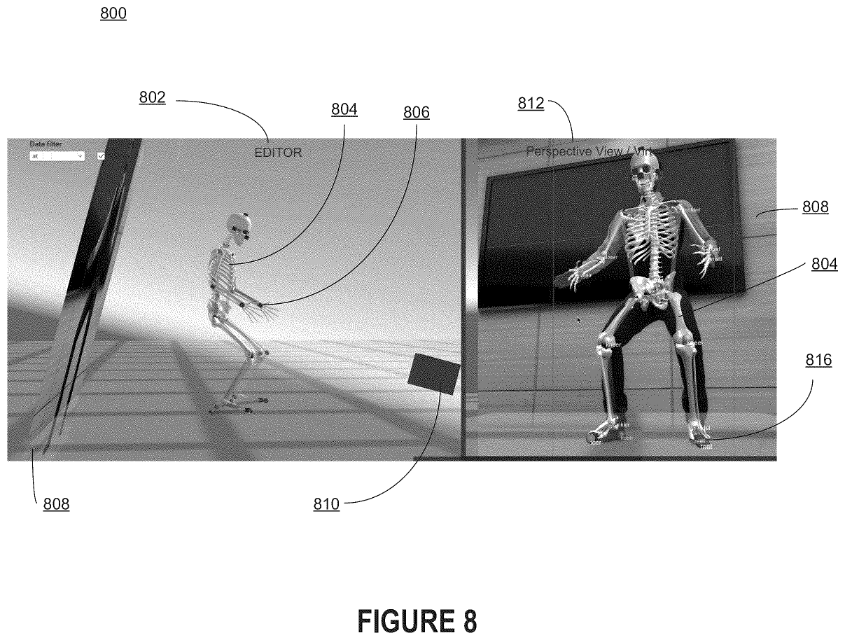

FIG. 8 depicts generated training data for training a machine learning model for the motion monitoring platform. For example, the schematic 800 depicts a first rendering 802 of an estimated pose 804 (e.g., a 3D skeletal representation) for a user, with a virtual camera 810, and an element (e.g., a wall 808) within the virtual scene. Keypoint 806 depicts an anatomical landmark (e.g., a wrist).

The second rendering 812 includes another view of the same scene, with the estimated pose 814, the keypoint 816 (which corresponds to another keypoint for the 3D skeletal structure). The element (e.g., wall 808) is depicted from in a different view.

### Processing System

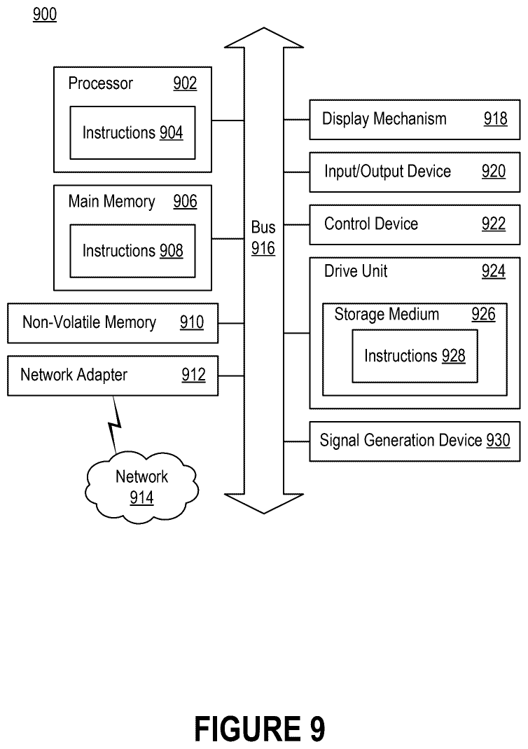

FIG. 9 includes a block diagram illustrating an example of a processing system 900 in which at least some operations described herein can be implemented. For example, components of the processing system 900 may be hosted on a computing device that includes a motion monitoring platform (e.g., motion monitoring platform 212 of FIG. 2).

The processing system 900 can include a processor 902, main memory 906, non-volatile memory 910, network adapter 912, video display 918, input/output devices 920, control device 922 (e.g., a keyboard or pointing device such as a computer mouse or trackpad), drive unit 924 including a storage medium 926, and signal generation device 930 that are communicatively connected to a bus 916. The bus 916 is illustrated as an abstraction that represents one or more physical buses or point-to-point connections that are connected by appropriate bridges, adapters, or controllers. The bus 916, therefore, can include a system bus, a Peripheral Component Interconnect (“PCI”) bus or PCI-Express bus, a HyperTransport (“HT”) bus, an Industry Standard Architecture (“ISA”) bus, a Small Computer System Interface (“SCSI”) bus, a Universal Serial Bus (“USB”) data interface, an Inter-Integrated Circuit (“I²C”) bus, or a high-performance serial bus developed in accordance with Institute of Electrical and Electronics Engineers (“IEEE”) 1394.

While the main memory 906, non-volatile memory 910, and storage medium 926 are shown to be a single medium, the terms “machine-readable medium” and “storage medium” should be taken to include a single medium or multiple media (e.g., a centralized/distributed database and/or associated caches and servers) that store one or more sets of instructions 928. The terms “machine-readable medium” and “storage medium” shall also be taken to include any medium that is capable of storing, encoding, or carrying a set of instructions for execution by the processing system 900.

In general, the routines executed to implement the embodiments of the disclosure can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in a computing device. When read and executed by the processors 902, the instruction(s) cause the processing system 900 to perform operations to execute elements involving the various aspects of the present disclosure.

Further examples of machine- and computer-readable media include recordable-type media, such as volatile memory devices and non-volatile memory devices 910, removable disks, hard disk drives, and optical disks (e.g., Compact Disk Read-Only Memory (“CD-ROMs”) and Digital Versatile Disks (“DVDs”)), and transmission-type media, such as digital and analog communication links.

The network adapter 912 enables the processing system 900 to mediate data in a network 914 with an entity that is external to the processing system 900 through any communication protocol supported by the processing system 900 and the external entity. The network adapter 912 can include a network adaptor card, a wireless network interface card, a router, an access point, a wireless router, a switch, a multilayer switch, a protocol converter, a gateway, a bridge, bridge router, a hub, a digital media receiver, a repeater, or any combination thereof.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments can vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method performed by a computer program executed on a computing device, the method comprising:
obtaining a volumetric video of a human,
wherein the volumetric video includes a set of frames, each of which includes a textured mesh representing the human at a corresponding one of a set of times;
generating a set of perspectives for a given frame of the set of frames in a virtual studio,
wherein the given frame includes a given textured mesh at a given time, and
wherein each perspective of the set of perspectives includes a two-dimensional (2D) projection of the given frame from a corresponding one of a set of virtual camera views;
generating a set of 2D skeletal representations for the set of perspectives;
determining (i) a set of keypoints corresponding to different anatomical landmarks across the set of 2D skeletal representations and (ii) confidence metrics for the set of keypoints;
determining, based on the confidence metrics, a three-dimensional (3D) skeletal representation for the human;
generating a transformed 2D skeletal representation according to a first transformation of the 3D skeletal representation from a reference perspective of the volumetric video to another perspective of the volumetric video; and
generating training data for training a machine learning model to estimate pose,
wherein the training data includes (i) the transformed 2D skeletal representation and (ii) a corresponding 2D rendering of the volumetric video.

2. The method of claim 1, wherein generating the set of 2D skeletal representations for the set of perspectives comprises:
for each frame of the set of frames,
generating a set of 2D positions for the set of perspectives, so as to generate multiple sets of 2D positions,
filtering frequencies of the multiple sets of 2D positions to smoothen temporal variations in the set of 2D positions; and
for each perspective of the set of perspectives,
generating the set of 2D skeletal representations based on corresponding filtered frequencies of the set of 2D positions for the given frame.

3. The method of claim 2, wherein determining the confidence metrics for the set of keypoints comprises:
generating a consistency metric for each keypoint of the set of keypoints,
wherein the consistency metric indicates a measure of temporal consistency over the set of frames for a corresponding keypoint of the set of 2D skeletal representations; and
generating, based on the consistency metric, a confidence metric for the corresponding keypoint.

4. The method of claim 1, wherein determining the 3D skeletal representation for the human comprises:
generating, based on the set of keypoints, a set of 3D skeletal representations corresponding to the set of frames;
filtering frequencies of each 3D skeletal representation to generate a temporally filtered 3D skeletal representation for each frame of the set of frames; and
generating the 3D skeletal representation for the human based on filtered frequencies for each 3D skeletal representation for the given frame.

5. The method of claim 1, wherein generating the set of perspectives comprises:
determining the set of virtual camera views, wherein each virtual camera view comprises:
(i) a first virtual camera angle, indicating an angle of virtual camera roll,
(ii) a second virtual camera angle, indicating an angle of virtual camera yaw, and
(iii) a third virtual camera angle, indicating an angle of virtual camera tilt; and
determining the reference perspective to include one of the set of virtual camera views.

6. The method of claim 1, wherein determining, based on the confidence metrics, the 3D skeletal representation for the human comprises:
generating weights, for the set of keypoints, corresponding to the confidence metrics;
triangulating, in accordance with the weights, a set of 3D keypoints corresponding to the set of keypoints,
wherein keypoints of the set of keypoints with greater weights are prioritized over keypoints with smaller weights; and
generating the 3D skeletal representation for the human based on the set of 3D keypoints.

7. The method of claim 1, comprising:
rendering the volumetric video in a volumetric scene that includes 3D renderings of elements; and
generating the corresponding 2D rendering of the volumetric video in the volumetric scene,
wherein the corresponding 2D rendering of the volumetric video is from the other perspective.

8. A computing device including:
(i) one or more processors; and
(ii) a non-transitory medium storing instructions that, when executed by the one or more processors, cause the computing device to perform operations comprising:
obtaining a volumetric video of a human,
wherein the volumetric video includes textured meshes representing the human;
determining a location in a volumetric scene that includes three-dimensional (3D) renderings of elements;
rendering the volumetric video in the volumetric scene such that the textured meshes are placed at the location in the volumetric scene;
generating, for a virtual camera of the volumetric scene, one or more view parameters;
determining a first transformation from a reference perspective of the volumetric video to another perspective of the volumetric video associated with the one or more view parameters;
generating, based on the one or more view parameters, a two-dimensional (2D) rendering of the volumetric video at a first time;
generating, in accordance with the first transformation, a transformed 2D skeletal representation for the first time based on a rendering of the volumetric video in a virtual studio; and
generating training data for training a machine learning model to estimate pose,
wherein the training data includes (i) the transformed 2D skeletal representation and (ii) the 2D rendering of the volumetric video.

9. The computing device of claim 8, wherein the instructions for generating the one or more view parameters cause the computing device to perform operations comprising:
determining, for the virtual camera:
(i) a virtual field of view indicating a solid angle of visible elements,
(ii) a virtual pitch angle, indicating a vertical incline in a virtual camera orientation,
(iii) a virtual roll angle, indicating a longitudinal rotation of the virtual camera orientation; and
(iv) a virtual camera position within the volumetric scene.

10. The computing device of claim 9, wherein the instructions for generating the one or more view parameters cause the computing device to perform operations comprising:
determining probability distributions corresponding to (i) fields of view, (ii) pitch angles, (iii) roll angles, and (iv) camera positions; and
stochastically determining, based on the probability distributions, (i) the virtual field of view, (ii) the virtual pitch angle, (iii) the virtual roll angle, and (iv) the virtual camera position.

11. The computing device of claim 8, wherein the instructions for determining the location in the volumetric scene cause the computing device to perform operations comprising:
generating a candidate location for the volumetric video in the volumetric scene;
rendering the volumetric video at the candidate location in the volumetric scene; and
determining that the volumetric video, rendered at the candidate location, and the 3D renderings of elements do not overlap within the volumetric scene.

12. The computing device of claim 8, wherein the instructions for determining the location in the volumetric scene cause the computing device to perform operations comprising:
determining probability distributions for components of positional coordinates in the volumetric scene; and
stochastically determining, based on the probability distributions, (i) a first horizontal coordinate, (ii) a second horizontal coordinate, and (iii) a vertical coordinate; and
determining the location in the volumetric scene to include a position corresponding to the first horizontal coordinate, the second horizontal coordinate, and the vertical coordinate.

13. The computing device of claim 8, wherein the instructions for generating the transformed 2D skeletal representation cause the computing device to perform operations comprising:
obtaining a 3D skeletal representation for the human,
wherein the 3D skeletal representation is based on a set of 3D keypoints corresponding to different anatomical landmarks associated with the volumetric video;
generating a 2D representation of the 3D skeletal representation from the reference perspective; and
generating the transformed 2D skeletal representation based on transforming, in accordance with the first transformation, the 2D representation of the 3D skeletal representation.

14. The computing device of claim 13, wherein the instructions for obtaining the 3D skeletal representation for the human cause the computing device to perform operations comprising:
generating a set of perspectives for a given frame of a set of frames in the virtual studio;
determining a set of 2D skeletal representations for the set of perspectives; and
generating the 3D skeletal representation for the human based on (i) a set of 2D keypoints and (ii) corresponding confidence metrics.

15. A non-transitory medium storing instructions that, when executed by one or more processors, cause a computing device to perform operations comprising:
obtaining volumetric videos of individuals,
wherein each volumetric video includes a series of textured meshes, in temporal order, representing a corresponding one of the individuals over time;
generating, for each of multiple virtual cameras in multiple volumetric scenes, a set of view parameters so as to generate multiple sets of view parameters,
wherein each set of view parameters is associated with a corresponding one of multiple transformations;
generating, based on the multiple sets of view parameters, two-dimensional (2D) renderings of the volumetric videos in the multiple volumetric scenes;
generating, based on the multiple transformations, transformed 2D skeletal representations from renderings of the volumetric videos in a virtual studio,
wherein each transformed 2D skeletal representation is related to an associated 2D rendering at an associated time; and
providing a training dataset including the transformed 2D skeletal representations and the 2D renderings to a machine learning algorithm that produces, as output, a machine learning model able to generate 2D estimates of poses based on 2D videos of individuals.

16. The non-transitory medium of claim 15, wherein the instructions for generating, for each of the multiple virtual cameras in the multiple volumetric scenes, the set of view parameters cause the computing device to perform operations comprising:
determining, for each of the multiple virtual cameras in the multiple volumetric scenes:
(i) a virtual field of view indicating a solid angle of visible elements,
(ii) a virtual pitch angle, indicating a vertical incline in a virtual camera orientation,
(iii) a virtual roll angle, indicating a longitudinal rotation of the virtual camera orientation, and
(iv) a virtual camera position within a corresponding one of the multiple volumetric scenes.

17. The non-transitory medium of claim 16, wherein the instructions for generating, for each of the multiple virtual cameras in the multiple volumetric scenes, the set of view parameters cause the computing device to perform operations comprising:
determining, for each of the multiple virtual cameras in the multiple volumetric scenes, probability distributions corresponding to (i) fields of view, (ii) pitch angles, (iii) roll angles, and (iv) camera positions so as to generate multiple sets of probability distributions; and
stochastically determining, based on each one of the multiple sets of probability distributions and for each of the multiple virtual cameras in the multiple volumetric scenes, (i) the virtual field of view, (ii) the virtual pitch angle, (iii) the virtual roll angle, and (iv) the virtual camera position.

18. The non-transitory medium of claim 15, wherein the instructions for generating the transformed 2D skeletal representations from renderings of the volumetric videos in the virtual studio cause the computing device to perform operations comprising:
generating multiple sets of perspectives for frames in the virtual studio,
wherein each frame includes a textured mesh at a given time, and
wherein each perspective of the multiple sets of perspectives includes a 2D projection of a given frame from a corresponding one of a set of virtual camera views;
generating sets of 2D skeletal representations for the multiple sets of perspectives;
generating multiple 3D skeletal representations based on the sets of 2D skeletal representations; and
generating the transformed 2D skeletal representations from the multiple 3D skeletal representations according to the multiple transformations.

19. The non-transitory medium of claim 18, wherein the instructions for generating the multiple 3D skeletal representations cause the computing device to perform operations comprising:
generating sets of 2D keypoints corresponding to anatomical landmarks across the sets of 2D skeletal representations;
determining a confidence metric for each 2D keypoint of the sets of 2D keypoints so as to generate sets of confidence metrics for the sets of 2D keypoints;
triangulating, based on the sets of confidence metrics, sets of 3D keypoints corresponding to the sets of 2D keypoints; and
generating the multiple 3D skeletal representations using the sets of 3D keypoints.

20. The non-transitory medium of claim 15, wherein the instructions cause the
computing device to perform operations comprising:
receiving a first video of a user over a time period;
estimating, based on providing the first video to the machine learning model, a set of 2D skeletal poses for the user over the time period;
generating an evaluation metric for the user,
wherein the evaluation metric quantifies a performance of an intended pose for the user; and
generating, for display on a user interface, instructions for improving the performance of the intended pose.
